(19) United States
(12) Patent Application Publication
(10) Pub. No.: US 2007/0112785 A1
(43) Pub. Date: May 17, 2007

(54) System and method for updating a storage medium

(75) Inventors: Christopher P. Murphy, Louisville, KY (US); Thomas Daddona, Long Beach, NY (US)

Correspondence Address: HOFFMANN & BARON, LLP, 6900 JERICHO TURNPIKE, SYOSSET, NY, 11791, US

(73) Assignee: Autup, Inc.

(21) Appl. No.: 11/588,975

(22) Filed: Oct. 27, 2006

Related U.S. Application Data
(60) Provisional application No. 60/734,563, filed on Nov. 8, 2005.
(60) Provisional application No. 60/734,941, filed on Nov. 9, 2005.

(51) Int. Cl. G06F 17/30

(52) U.S. Cl. 707/10

(57) ABSTRACT

A method for updating the information of a distributable storage medium that is coupled to a medium reader of a computer. The distributable medium including a recording of a first updateable application and the server including a recording of a second updateable application. The method comprising the steps of connecting the computer to a server, reading a status of the files of the first updateable application on the medium and a status of the files of the second updateable application on the server, comparing the status of the files of the first updateable application to the status of the files of the second updateable application, identifying updated files of the updateable application on the server and selectively transmitting the updated files to a database in the volatile memory of the computer, integrating the updateable application on the distributable storage medium with the updates from the updateable application on the server in volatile and non-volatile memory.

### CROSS-REFERENCE TO RELATED APPLICATIONS

This application claims the benefit of U.S. Provisional Application No. 60/734,563 filed Nov 8, 2006 and U.S. Provisional Application No. 60/734,941, filed Nov. 9, 2005, the contents all of which are incorporated herein by reference.

### FIELD OF THE INVENTION

The present invention relates to a system and method for updating information on a storage medium and more specifically to a method for updating information recorded on a distributable storage medium.

### BACKGROUND OF THE INVENTION

Distributable storage mediums include data such as music, images, video, text and software programs that are fixed recordings on media such as a Compact Disk (CD) or a Digital Video Disk (DVD). Distributable storage media can advantageously provide large files of data such as high resolution images and video as well as music rapidly in response to a user's demand. Distributable storage mediums, however, are most commonly provided to consumers as a fixed recording with little or no capability of being updated. This presents a significant limitation for applications on distributable storage mediums such as electronic magazines, resource materials, video games, software programs or catalogs, for example, where a vast array of data can rapidly become stale by unforeseeable events and are fixed on the storage medium and cannot be changed after distribution.

In contrast, a computer connected to a server over an external connection such as the Internet can receive distributable information on a storage medium that can be readily updated. The transfer of information on the Internet, however, has technical limitations. Even the present faster mediums for Internet data transfer cannot instantaneously provide sizable amounts of information such as sound, graphics, images or video at high resolution due to limitations such as data transmission rates and bandwidth. These limitations result in frustratingly long download times to transfer large amounts of information that consumers desire to experience instantaneously. This data transfer problem over external communications is the distinct advantage of distributable storage media that can rapidly respond to a user's demand and provide quality information.

Various techniques have been disclosed for disseminating current information recorded on media, such as a Compact Disk (CD) or a Digital Video Disk (DVD). Generally, the techniques rely on using a hard disk of a receiving device to receive and provide the current information. For example, U.S. Pat. No. 6,131,088 to Hill is directed to methods for accessing product information data that include transmitting a data request query related to a selected product from a remote computer to a main computer. The method includes identifying a subset of product data related to the selected product stored in the memory of the main computer based on the data request query, transmitting textual data from the subset of product data from the main computer to the remote computer, transmitting only updated graphics data from the main computer to the remote computer, and combining the textual data received from the main computer with graphics data stored in the memory of the remote computer to provide complete product information data related to the selected product. As discussed in the '088 patent, the graphics data is stored on a hard drive of the remote computer.

Similarly, U.S. Pat. No. 6,029,142 to Hill is directed to an apparatus and method for displaying product information data relating to a product. The method includes the steps of transmitting a data request from a remote computer to a main computer, transmitting variable data and display information from the main computer to the remote computer, transmitting updated constant data from the main computer to the remote computer, and storing the updated constant data in the memory of the remote computer. The memory referred to in the '142 patent also refers to a hard drive of the remote computer.

Several disadvantages may exist by providing current information from a hard drive of a remote computer device. One disadvantage may relate to data staleness. For example, if an interruption of service occurs while providing the current information, remnants of information, such as old product prices, may still reside on remote computer devices and be relied upon in decision making. Another disadvantage may relate to data security. For example, a provider of certain current information may only desire an authorized user to view the current information. By storing information on the hard drive of the remote device, other unauthorized individuals may gain access to the current information, regardless of whether the remote device is active.

As such, there is a need to combine the advantages of the distributable storage media and an external source of information to update the information on the storage media for dissemination, while minimizing data staleness and security issues. Furthermore, a method for updating distributable storage media is needed that can update the information on the storage media for dissemination to a user.

### SUMMARY OF THE INVENTION

A method for updating the information of a distributable storage medium that is coupled to a medium reader of a computer. The distributable medium including a recording of a first updateable application and the server including a recording of a second updateable application. The method comprising the steps of connecting the computer to a server, reading a status of the files of the first updateable application on the medium and a status of the files of the second updateable application on the server, comparing the status of the files of the first updateable application to the status of the files of the second updateable application, identifying updated files of the updateable application on the server and selectively transmitting the updated files to a database in the volatile memory of the computer, integrating the updateable application on the distributable storage medium with the updates from the updateable application on the server in volatile and non-volatile memory.

The step of reading can further include constructing a relational database in the volatile memory of the computer and the step of comparing can include populating the relational database with values identifying the name and location of the files and field values to be loaded by the application.

The method can further include in the step of disseminating loading a predetermined amount of information initially and loading the remaining information on demand of the user. The method can also include a load module that is connected to the updateable application on the server. The load module is used to change the information of the updateable application.

The method can include a first set of information and the information is changed on the updateable application on the server. The method includes information on the updateable application on the medium that is audio and the audio recorded of the updateable application on the server can be changed.

The method can include video and the video recoded on the updateable application on the server can be changed. The method stores updated information from the server in volatile memory on the computer for dissemination.

A method for updating a distributable storage medium coupled to a computer that includes a distributable storage media reading device. The method comprising the steps of connecting the computer to a server. The distributable medium including a recording of a first updateable application and the server including a recording of a second updateable application. Reading a status of the files of the first updateable application on the medium and a status of the files of the updateable application on the server by an update module of the first updateable application, comparing the status of the update modules of the first updateable application on the medium to the status of an update module of the second updateable application on the server to identify changes in the status of the update module of the second updateable application on the server, replacing the update module of the first application with the update module of the second application that includes changes in the volatile memory of the computer, reading the status files of the updateable application on the medium and the status of the files on the server, identifying updated files of the updateable application on the server and transmitting the updated files to a database in the volatile memory of the computer; integrating the updateable application on the distributable storage medium with the updated information from the updateable application on the server in volatile memory and disseminating the information of the updatable application on the distributable medium with the updated information from the updateable application on the server.

The method can also include in the step of reading the status of the update module of the first updateable application constructing a relational database in the volatile memory of the computer. The method can also include in the step of comparing the files of the updateable applications populating the category arrays of the relational database with values identifying the name and location of the files to be loaded by the first updateable application. The method can further include in the step of comparing the files of the updateable applications populating the category detail arrays of the relational database with values identifying the name and location of the files to be loaded by the first updateable application.

In another aspect of the present invention, a method of updating information recorded on a storage medium includes comparing a first file associated with a first application included on a distributable storage medium of a first computer with a second file associated with a second application on a server, the first file and second file being at least one of a data file and a program module, constructing a database in volatile memory of the first computer, the database including information on the location of at least one of the first file and second file to load into the volatile memory based on the comparison; and disseminating information associated with the at least one first and second file using the database in response to a user request.

The method also can include establishing a network connection between the first computer and the server. The method can further include removing the database from the volatile memory in response to a user request.

In one preferred embodiment, the method also may include loading automatically a partial amount of information from the first application into the volatile memory of the first computer. The method also can include loading on demand a portion of the information into the volatile memory of the first computer in response to a user request.

A system, as well as articles that include a machine-readable medium storing machine-readable instructions for implementing the various techniques, are disclosed. Details of various embodiments are discussed in greater detail below.

### BRIEF DESCRIPTION OF THE DRAWINGS

For a better understanding of the nature and objects of the present invention, reference should be made to the following detailed description taken in conjunction with the accompanying drawings, in which:

FIG. 1 illustrates a block diagram of a system for updating a distributable storage medium according to the present invention;

FIG. 2 illustrates the processing steps associated with a method for updating a distributable storage medium of the present invention;

FIG. 3 illustrates a block diagram of a base module, an update module and the application modules of the present invention;

FIG. 4 illustrates the processing steps of the base module of the present invention;

FIG. 5 illustrates the processing steps associated with the update module of the present invention;

FIG. 6 illustrates the processing steps associated with loading the category array functions of the present invention;

FIG. 7 illustrates a block diagram of one embodiment of the memory resident in the relational database of the updateable application of the present invention;

FIG. 8 illustrates a block diagram of one embodiment of the category array links of the present invention;

FIG. 9 illustrates the processing steps associated with loading the category detail array functions of the present invention;

FIG. 10 illustrates the start layer level 0 and three additional layers of the display of the updateable application of the present invention as an updateable digital catalog;

FIG. 11 illustrates the assembled layers of the display of the updateable application of the present invention as the updateable digital catalog;

FIG. 12 illustrates the block diagram of one of the functions of the second movie/module of the display of one embodiment of the updateable application of the present invention;

FIG. 13 illustrates the processing steps associated with loading the index module of the present invention;

FIG. 14 illustrates the upload module category processing steps associated with uploading category changes of the present invention;

FIG. 15 illustrates the upload module category detail processing steps associated with uploading category detail changes of the present invention;

FIG. 16 illustrates a block diagram of example components included in an updateable digital catalog;

FIG. 17 is an example of a graphical user interface for entering company information;

FIG. 18 is an example of a graphical user interface for previewing entered company information;

FIG. 19 is an example of a graphical user interface for associating an image with company information;

FIG. 20 is an example of a graphical user interface for providing category functions according to the present invention;

FIGS. 21-25 are examples of graphical user interfaces for adding categories according to the present invention;.

FIG. 26 is an example of a graphical user interface for setting a sort order of categories according to the present invention;

FIGS. 27-34 are examples of graphical user interfaces for updating category information according to the present invention; and

FIGS. 35-38 are examples of graphical user interfaces for adding and updating product information according to the present invention.

Like reference symbols in the various drawings indicate like elements.

### DETAIL DESCRIPTION OF THE PREFERRED EMBODIMENTS

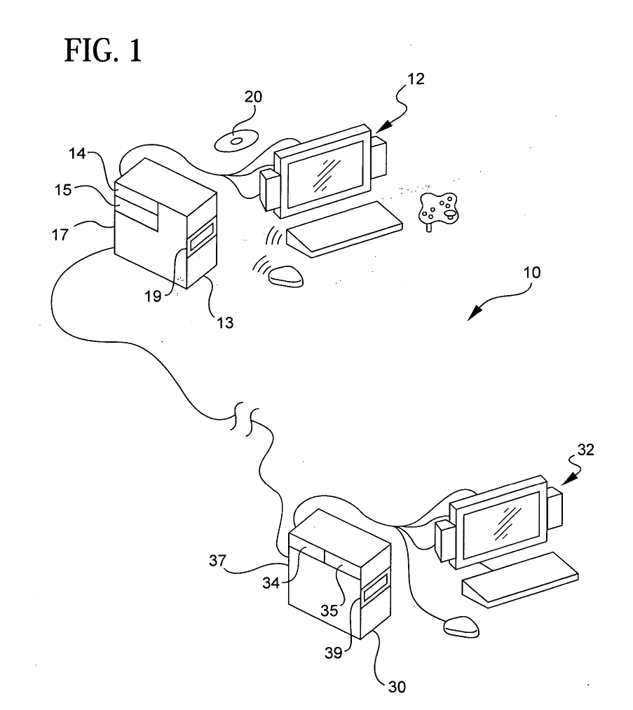

Referring to FIG. 1, a system and method for updating a storage medium 10 includes a user interface device 12, a computer 13 and one or more standard servers 30. Interface 12 can be any type of device that disseminates information to produce visual, aural, olfactory and tactile sensors in conjunction with computer 13.

Computer 13 is preferably a standard computer that includes at least one central processor unit coupled to non-volatile memory 14, volatile memory 15 and an external communication interface 17. Computer 13 is coupled to a distributable media player 19 that reads and provides a source for the dissemination of information.

External communication interface 17 provides for the transfer of information between device 12 and an external information source such as server 30 through any kind of network using a standard connection and protocol such as those for a telephone line, cable, as well as wireless connection. In the preferred embodiment exterior interface 17 is an Internet connection that is a high speed connection such as broadband or wireless.

Media player 19 reads data from a distributable storage media 20. Media player 19 preferably reads storage media 20 optically by means of a laser, but it can include alternative forms of reading recorded data from distributable medium 20 such as other forms of optical reading as well as magnetic reading. Medium 20 is preferably a compact disc (CD) or a Digital Video Disc (DVD), diskette or memory stick, for example, that is distributable and compatible with media player 19.

Standard server 30 includes at least one central processor unit, a user interface 32, a non-volatile memory 34, a volatile memory 35, an external communication interface 37 and a device 39 for loading data into the memory. Server 30 and computer 13 are coupled through their respective external communication interfaces 17 and 37.

The process provided by computer 13, server 30 and media player 19 is operating system independent and can be used across multiple developmental tools. The requirements for the development tool include the ability to compile and run independently in a stand alone application, the ability to read and display data dynamically, and the ability to perform remote reads to the Internet to access data stored in a current information directory. In one preferred embodiment, Macromedia Flash is used as the developmental tool for the display of visual and auditory information.

In the preferred embodiment, system and method 10 provides the ability for an application to read data from media 20 and accesses data from server 30 via the Internet. This data can be provided using any programming language that will read and transfer data. An Internet read can be completed using asp, php, and Coldfusion, etc., for example. Macromedia Coldfusion is preferably used in this embodiment with Macromedia Flash being used for direct reads. The choice of Macromedia Coldfusion is based on the ease of interaction with Macromedia's Flash which provides access to multiple Internet language interaction as well as interaction with Web-Service modules for data transfer. It is understood that other developmental tools can provide the same capabilities.

As shown in FIGS. 1, 3 and 2, in the preferred embodiment, system for updating a storage medium 10 integrates an application 40 with an update module 42 to become an updateable application 43 that is recorded on distributable medium 20. Application 40 can be a digital catalog, book, magazine, recording of music and/or video, as well as a software application. Update module 42 selectively provides information for dissemination based on the initial predetermined priorities of updateable application 43, the currency of that information and the demand of the user.

Server 30 initially preferably hosts a mirror image of base module 52, all application modules 54 including the update module 42 and all the information such as data/images on the distributed medium 20. Server 30 also hosts or can be connected to application 47 and a data load module 45 that allows an authorized user to delete, add or modify information on server 30 in order to provide updated information that is current or correct errors, for example. Server 30 is preferably a library or storage vehicle that is a source of updated information to updateable application 43 on computer 13.

Updateable application 43 receives both updated and non-updated information from server 30 and identifies the updated application modules 54 and information for dissemination from computer 13 based on the initial predetermined priorities evaluated at startup, an update of the predetermined priorities from server 30 or by the loading of update module 46 from server 30 into updateable application 43. Other factors that affect the dissemination of information to a user include the currency of that information and the demand of the user. It is understood that server 30 can initially be a mirror image of application 43 or already have updated portions included into application 47.

The development and integration of distributed medium update module 42 with application 40 requires the evaluation of the functions, data components and presentation elements, such as modules 54, files and fields that include items such as display forms and functional components and size. This development and integration can be done prior to or after the development of application 40, but preferably results in functional partitions and a hierarchical data structure in a database that is maintained in volatile memory 15 of computer 13 during the time in which the user receives information through system 10. In the preferred embodiment, the database is a relational database for each application 40 that is designed based on the needs of update module 42 to efficiently load and disseminate a given element from updateable application 43 on medium 20. The size of modules 54 and other files is reduced to improve the ability of updateable module or current information directories (CID) 46 to efficiently load and disseminate a given element from updateable application 43 and/or 47 on server 30.

While the relational database is described as being created in the volatile memory 15 of remote computer 13, it is understood that a relational database program and a pre-existing relational database can be stored on medium 20 that directly accesses the relational database without any additional software installed on remote computer 13 from medium 20 or server 30.

Organization of the Updateable Application

The hierarchical data structure of updateable application 43 can include a plurality of levels and can defme a unique structure for each application 40. In this illustrative example, a category file 57 is used to describe the highest or topical level of information in the data structure such as a display screen viewable on remote user interface 12 and a category detail file 58 is used to describe the different lower levels of information that support each category file 57, such as one display field in the display screen. Additional category detail files 58 can define in a third and lower levels of the data base hierarchy the length or dimensions of the display field and type of characters, default values, criteria for acceptable data and associated prompts for example. Each category file 57 has one or more category detail files 58 that can provide additional information. Category files 57 and category detail files 58 can include graphics, images, audio or video, for example, in any compatible format as well as individual characters, strings and text files depending upon the need for updating a given application 40.

The data in updateable applications 43 and 47 is stored in this preferred embodiment in any Open Database Connectivity Compliant (ODBC) database or in text files and a data storage process that uses a somename.txt naming convention, wherein somename identifies the content of text files. The text files can be created from any word processing software or Notepad in the Windows operating environment. The use of somename.txt files is also advantageous in that some development tools may not support direct access to ODBC compliant databases without a web server being present. It is understood that equivalent alternative database structures, text file and access methods can be developed to perform this function.

In order to provide the widest compatibility, somename.txt files are preferably used with system 10 so that the data can be read directly from medium 20 independently from any other applications. Thus, the method for updating a storage medium is effectively a stand alone application used in conjunction with computer 13 and server 30 that does not install any applications or data in non-volatile memory 14 on computer 13. This simplifies compatibility issues and eliminates any stale data issues because the updated information disseminated to the user is solely retained in volatile memory 15.

The data that updateable applications 43 and 47 loads can be any kind of information as defined herein and includes image files, video files, text files, graphic files, audio files and/or operation modules. These files build updateable applications 43 and are only loaded for dissemination upon request based on the user's demand or logically predictable for near term demand by the user. Thus, update module 46 is constructed to only download the data that has changed from that recorded on medium 20, and then only to download the data that needs to be disseminated to the user. The on demand loading method used by system 10 reduces bandwidth requirements and increases the responsiveness of the application when it is loading from update modules 43 and/or 47.

The method for updating a storage medium includes the gathering of data from the two separate locations, a distributable storage medium 20 and a server 30, comparing that data and the constructing a database that will inform updateable application 43 where to access the remaining data. All of the remaining data is loaded on demand to increase the performance of the application.

Preferably, the method for updating a storage medium provides additional information to the fixed recorded updateable application 43 on medium 20 that overlays and/or is added to the recorded information on medium 20. The changes and updates to the recorded data and application 43 may seamlessly overlay the original dissemination of recorded information from medium 20 such that the disseminated information is always current and accurate. Every production run of software, data such as files or images will be unique and fixed at the time of production. However for the user, the method for updating a storage medium provides the capability for every version to disseminate the same information even though each version may need to access different amounts of data from a current information directory (‘CID’) or update module 46 on server 30.

For example, a company producing a digital catalog on a CD-ROM over a two year period using the method for updating a storage medium technology and mailing the catalogs quarterly to disseminate eight versions will result in each CD-ROM from each mailing displaying the same and most current information from server 30 when run in a computer with an active Internet connection.

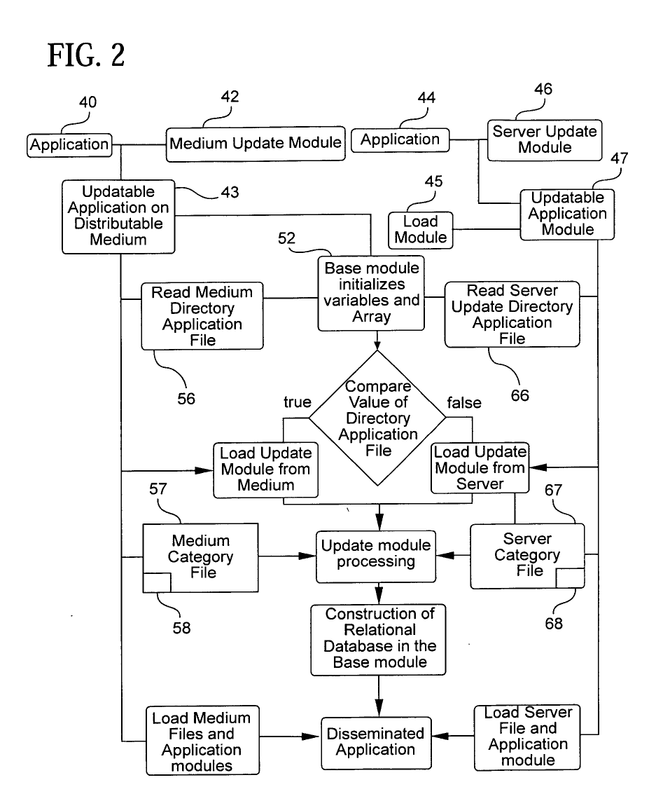

Continuing with FIGS. 1 and 2, application 40 is also evaluated for how much data is required on startup and how much data can be loaded on demand. In the preferred embodiment, this evaluation prioritizes based on how much data needs to be disseminated immediately upon startup, the file sizes and load times for the different files in application 40.

Component Modules of the Updateable Application

Application 43 includes a directory application file that defines values and/or version numbers for the identification of each module, file and display form field as described previously. Application 47 on server 30 also includes a directory application file that can be updated with current information through load module 45 via user interface 32 or external interface 37.

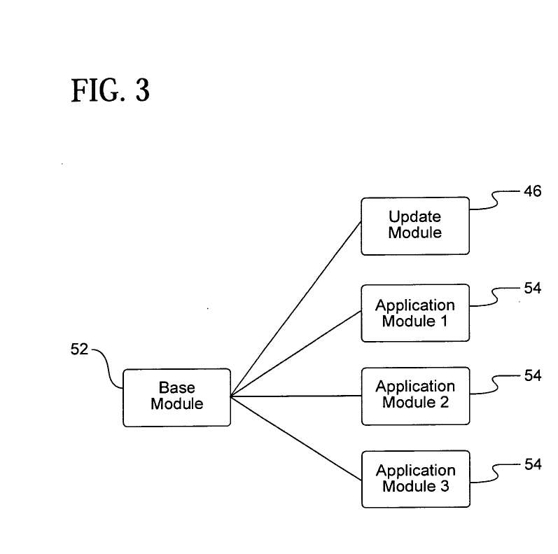

Referring now to FIGS. 2 and 3, updateable application 43 in this preferred embodiment includes a base module 52 that functions as a holding module into which one or more fuictional component application modules 54 are selectively loaded with update module 42. Each component application module 54 partitions or segregates selected functions of application 43 such that changes to any one function only requires that component application module 54 to be updated. This partitioning also provides a fast read and load for application modules 54. Component application modules 54 vary in size depending upon the intended application and can require as little as 3 kilobytes of memory, for example.

Processing Steps Associated with the Base Module

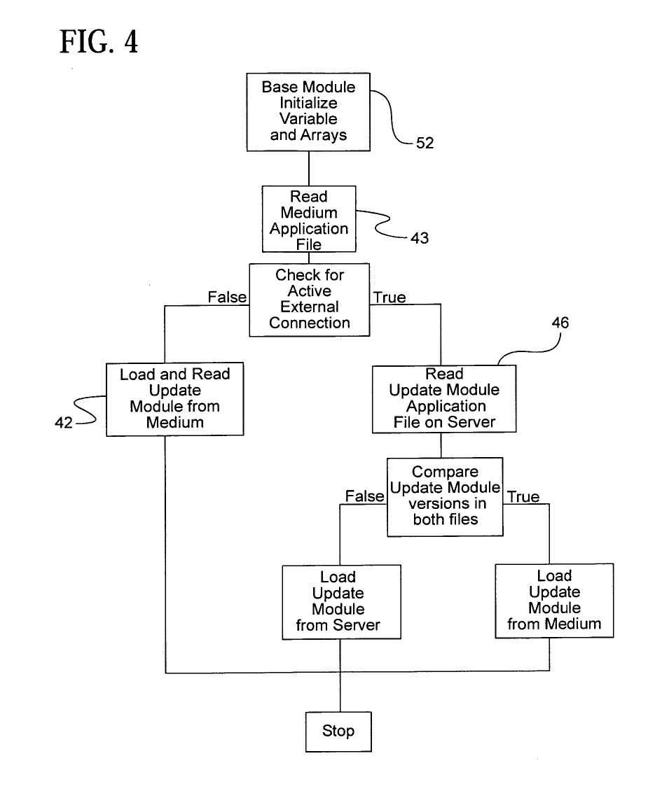

As shown in FIGS. 1, 3 and 4, update module 42 includes an initial startup application file that identifies the priority of application modules 54 for loading upon the initial startup of updateable application 43. The startup application preferably includes records with an identifiable version and a module name field for loading from medium 20.

Base module 52 initially reads application files 54, creates and initializes the universal variables with default values, creates the arrays for the relational database and initializes the module containers in volatile memory on computer 13. This results in defining the variable locations for each application module 54. Base Module 52 then reads a directory application file 56 for update module 42 and attempts to establish a connection through external interface 17 to server 30. The external connection of computer 13 is preferably accomplished automatically, but can be accomplished by prompting a user to establish an Internet connection that results in a connection with external communication interface 37 of server 30. If computer 13 cannot acquire a connection with server 30, the entire updateable application 43 and data base is loaded from medium 20. Update module 43 calls a load from updateable application 43 and sets the application modules to be loaded to the application modules distributed on media 20. After the application module 54 locations are set to the media 20, the category array 57 is constructed using the category data file from media 20.

The process for loading from updateable application 43 on media 20 is to read the category file and loop through the records in category file and loading the file fields into the category array 57 until the end of the file is reached. Upon reaching the end of file, category array 57 is sorted and the function for load category detail 58 from updateable application 43 is called.

The function for loading category detail arrays 58 checks to see if the passed value is greater than the length of the category array 57. By looping through the category array the related category detail files are read from the media and processed. The category detail records are loaded into the related category detail array.

If a connection with server 30 is established, directory application file 66 of update module 46 on server 30 is read. If directory application files 56 and 66 of update modules 42 and 46, respectively, are equal indicating the file structure in the update module 46 has not been changed, base module 52 loads update module 42 from updateable application 43. If the directory application files 56 and 66 of the update modules 42 and 46 are unequal indicating the file structure of update module 46 has been changed, base module 52 loads update module 46 from updateable application 47. The base module transfers control at this point to the selected update module 42 or 46. At this point base module 52 waits for the field, arrays and module containers to be provided values from the selected update module 42 or 46.

Processing Steps Associated with the Update Module

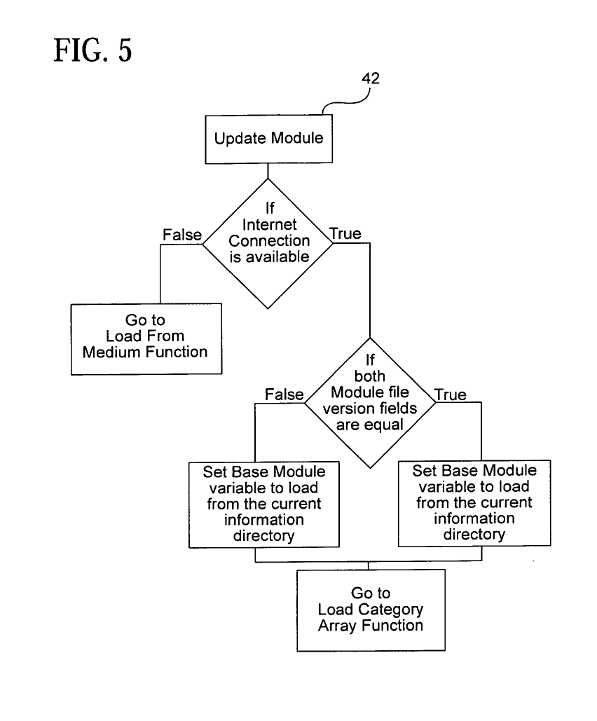

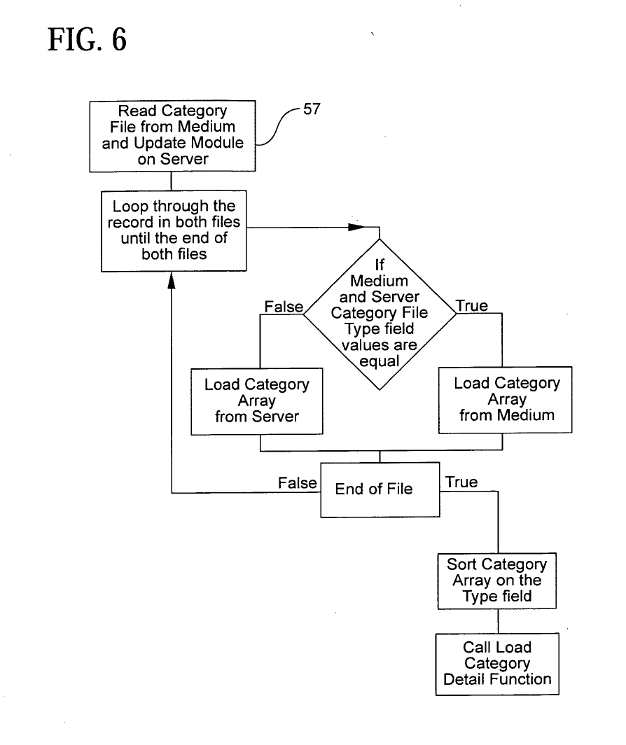

As shown in FIGS. 5 and 6, the preferred embodiment using a connection with server 30, update module 46 and updateable application 43 is described. It is understood that the use of the update module 42 and updateable application 43 without an external connection to server 30 is a separate aspect of the preferred embodiment that draws from update module 42, application modules 54 and updateable application 43 and shares the findamental process, construction, priorities for loading on demand and file partitioning for reduced loading times with update module 46, application modules 66 and updateable application 47.

Processing Steps Associated with Constructing the Database in Volatile Memory

Referring now to FIGS. 1, 2 and 6, after each of the application module load locations are identified, update module 42 or 46 constructs and stores the relational database in the base module 52 in volatile memory 15 of computer 13. The relational database constructed by update modules 42 and 46 is a critical part of the system and method for updating a storage medium 10. This database provides the bulk of the data used in an application and directs the application where to find the remaining data.

Update module 42 or 46 verifies an external communication is established with server 30, identifies the location for each of the additional application modules from updateable application 47 and initiates a read and comparison of the category files of updateable applications 43 and 47. The comparison evaluates whether a value in a critical field of the category file such as the version number, is equal or not. In this preferred embodiment, when the value of the version fields are equal it means the files are the same and a value of zero is stored to indicate medium 20 as the source of that category file. When the fields are unequal, a value of 1 will be stored telling updatable application 43 to get that category detail file from updateable application 47 on server 30.

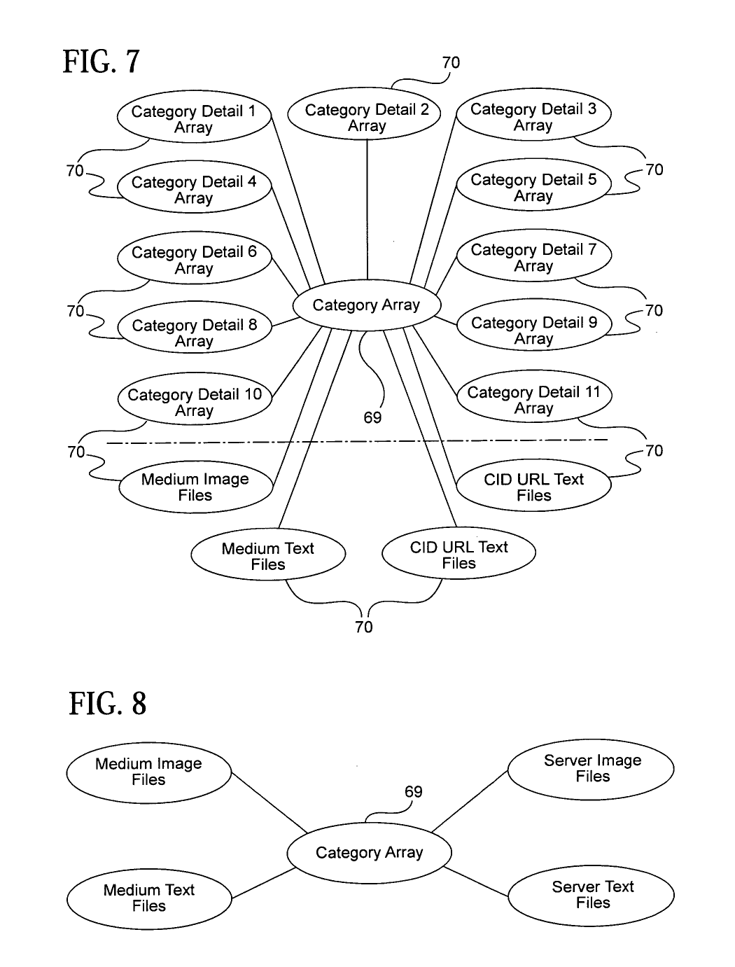

FIG. 7 illustrates a block diagram of one embodiment of the relational database. As shown in FIG. 7, update module 42 or 46 builds a category array 57 or 69 that can include non-updated category file values from updateable applications 43 and updated category file values from updateable application 47. Category array 69 category file values preferably identify the location of image, text and audio files that are resident on both medium 20 and server 30.

Example Data Links Included in the Database

Referring now to FIG. 8, the file and database structure category array 69 preferably includes information such as fields named file position, version number and type. In more complicated applications the number of fields in the category files and category array 69 can be greatly expanded and can include version numbers for multiple files. These different version numbers can allow only part of the related data to be loaded from updateable application 43 or updateable application 47 using update modules 42 or 46. The relational database constructed by update module 42 or 46 defines the relationship between each category array 69 and the one or more related category detail arrays 70. Category array 69 is linked to image, text, video and audio files on medium 20 and/or server 30.

Processing Steps Associated with Loading the Category Detail Array in Volatile Memory

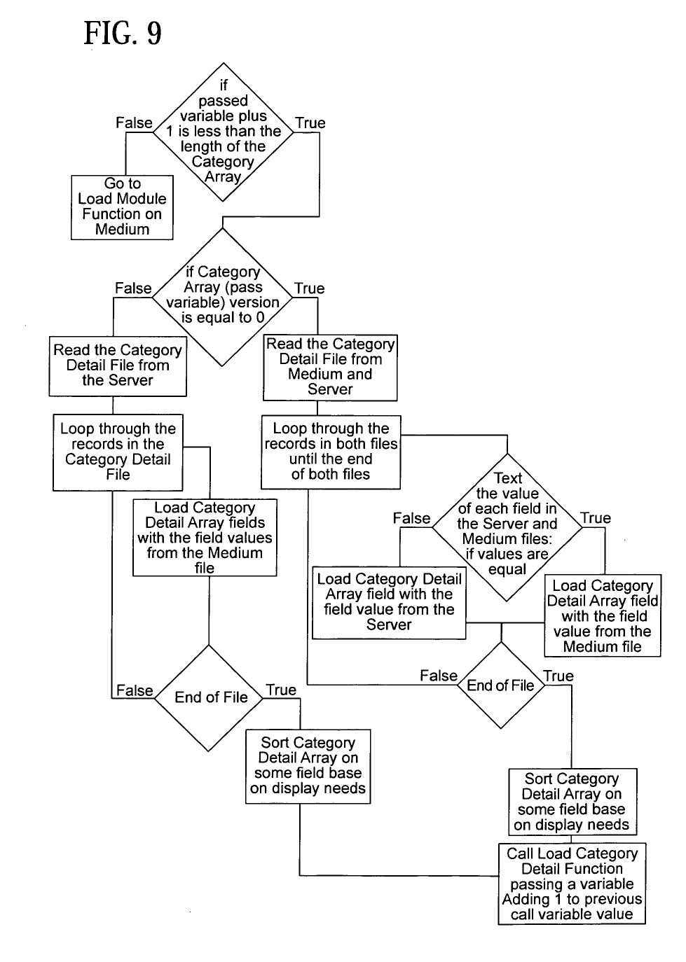

As shown in FIGS. 1, 2, 7 and 9, the files in category detail array 70 are read using a loop based in the category array. For each element in the category array the related category detail control files are read and a field-by-field comparison of the field values of each file is performed as described previously for category array 69. If the field values of the two respective files from updateable applications 43 and 47 in detail file are equal, the record from updateable application 43 is loaded into related category detail array 70. If the field value is unequal, the record from updateable application 47 is loaded. Upon completion of loading arrays 69 and 70, application modules 54 and/or 64 are loaded respectively from updateable applications 43 and 47.

If an Internet connection is established with server 30, update module 42 uses the Internet to read directory application file 66 of updateable application 47 on server 30. Update module 42 then compares directory application file 56 of application 43 on medium 20 to directory application file 66 on server 30. If directory application file 66 of updateable application 47 is equal directory application file 56 of updateable application 43, is loaded into base module 52. If directory application file 66 is not equal to directory application file 56, directory application file 66 is loaded into base module 52 from updateable application 47 on server 30 via the Internet. The loaded directory, either application file 56 or 66 is retained in volatile memory 15 of computer 13.

The comparison of directory application files 56 and 66 by update module 42 is preferably based on a version field for each record, but it can include any kind of evaluation, such as a field-by-field comparison that distinguishes when updateable application 47 has new information that supersedes the information of updateable application 43. System 10 preferably loads as much data as possible from application 43 and only loads data that is different from application 47 via the Internet.

Update modules 42 and 46 identify and specify the location of program elements and the different forms of information for the dissemination of information from updateable applications 43 and 47. As stated previously, in one preferred embodiment of the method for updating a storage medium is described herein using an updateable digital catalog (UDC) that uses Macromedia Flash as the development tool for the display of information. Macromedia Flash as used herein is an animation development tool that works similar to the two dimensional animations of most of the cartoons. In addition to animation ability, Macromedia Flash has the ability to read, process and display data. It is understood that is only one embodiment and that other embodiments employing other development tools are encompassed by this process.

The Display Module of the Present Invention

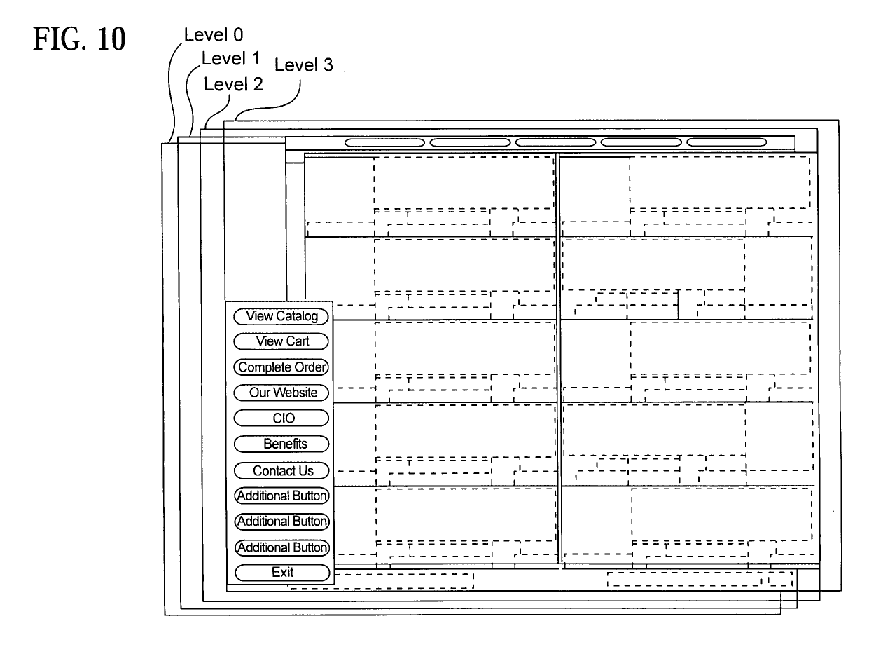

Reference will now be made to an updateable digital catalog (‘UDC’) using the system and method of the present invention to assist in describing the display module. Referring to FIGS. 1, 2, 10 and 11, the display of applications 43 and 47 is preferably loaded in layers on interface device 12. Each layer can be defined as a movie or module that can be moved independently. In addition, layers can be added or removed to bring addition characters and scenery to the movie. For example, a base or start layer can be a solid blue the size of the movie screen. A background of mountains can be the next level higher. The mountains can cover some of the solid blue base level so when the viewer looks through the layers they would see mountains with a blue sky and the blue base layer beneath the mountains is hidden. The next higher layer can be clouds and the area of the layers under the clouds would also be hidden. Layers can move, for example the clouds can move from left to right across the screen covering a different area with each move and giving the appearance of depth. Layers can be as simple as a piece of text, symbol, logo or trademark and include or exclude audio elements.

The start movie provides the background display area of the catalog and includes one or mores movies layers above the background. In this preferred application, the four movies are stacked to make the viewable images. Based on the level of the new layers containing characters or scenery some of the lower levels may be hidden and layers above it may cover part of the characters or scenery.

The base level is numbered 0 and all subsequent layers, movies, are loaded in relation to the base movie. To further enhance the visual effects, each module/movie can have many levels within it. Applications 43 and 47 are constructed such that modules/movies can be loaded individually and yet interact with each other. Using the UDC as an example, the employment of the movies to disseminate information using the method for updating a storage medium is described as follows:

Module/Movie 1—Start, this is the base of the application. It is loaded at level 0 and provides the background for the application. This movie provides a rectangular layout the size of the movie screen and the necessary code to load the remaining application. This module is a storage container and a movie screen on which the projector play the remaining movies.

Module/Movie 2—As shown in FIGS. 1, 7 and 2, update module 42 or 46 includes in the construction of the database the information for the dissemination of application 43 or 47. As described previously, updateable application 43 may perform this construction with or without an external interface.

The update module/movie or CID included in update modules 42 and 46 and preferably has only one visible field. This field is a text field that informs the user that either the update module/movie has updated the catalog in this one preferred embodiment of updateable application 43 or informs the user to connect to the server so that the catalog can be updated.

The update module/movie loads the directory for updateable application 43 in update module 42 to assign the location of the remaining movies to be loaded. The update module/movie then creates the data and populates the fields in the Start and Company Information movies. The update module/movie can be loaded from medium 20 or server 30. The directory of update module 42 on medium 20 and update module 46 on server 30 are read and then the values indicating the status of the files are compared. If the values are different in update modules 42 and 46, update module 46 is loaded. If the values are equal, update module 42 is loaded. If an Internet connection is not established or a connection with update module 46 on server 30 is not achieved, the update movie/module will only read and load the information from medium 20 into the relational database.

Using the loading of update module 46 as an example, a Company Name, Address, City, State, Zip, Phone, Fax and Toll Free number from the server is loaded into update module/movie for display. The update module/movie then tests the module versions and sets variables for the remaining movies so that they are pointing to the correct directory for loading from the database of either medium 20 or server 30. The update module/movie then creates the program resident relational database.

The relational database of the update module/movie reads the category file and category detail file data from medium 20 and server 30 and loads the relational database. When updated information is provided, the database will point to that information in updateable application 47 for loading from server 30.

Whenever possible the data is loaded from the medium 20 as this provides the faster response time and limits the data required from the server 30. The key to the performance is to limit the amount of data loaded from external sources such as the Internet to reduce the load time.

The database that results from the update module provides the bulk of the data used in the updating process and directs the application where the information and data for the UDC is stored.

If there is an external connection to server 30, the update module constructs the relational database using that external interface to connect with update module 46 from server 30. This update module reads the files from both medium 20 and server 30 and then compares the values. Based on the comparison of the files, the update module constructs a series of category arrays 69 and 70 that hold the current data and the location of any on-demand data. The on-demand data can be stored on medium 20 or in update module 43 in volatile memory. The second way to construct the database is solely using medium 20 and application 43 when access to update module 46 and server 30 is not established. In this instance, the movie module reads only from medium 20 and points all on-demand content to update module 42.

Once the database is created, files above the line are constructed and stored in base module 52. The medium 20 and update module 46 URL files are loaded dynamically based on user interaction and are linked based on fields in the stored arrays. Each of the category detail arrays are also linked to files that are loaded dynamically based on fields in the category detail array and user interaction. The images and or additional text are loaded from either medium 20 or through an external connection to server 30.

Navigation Module of the UDC

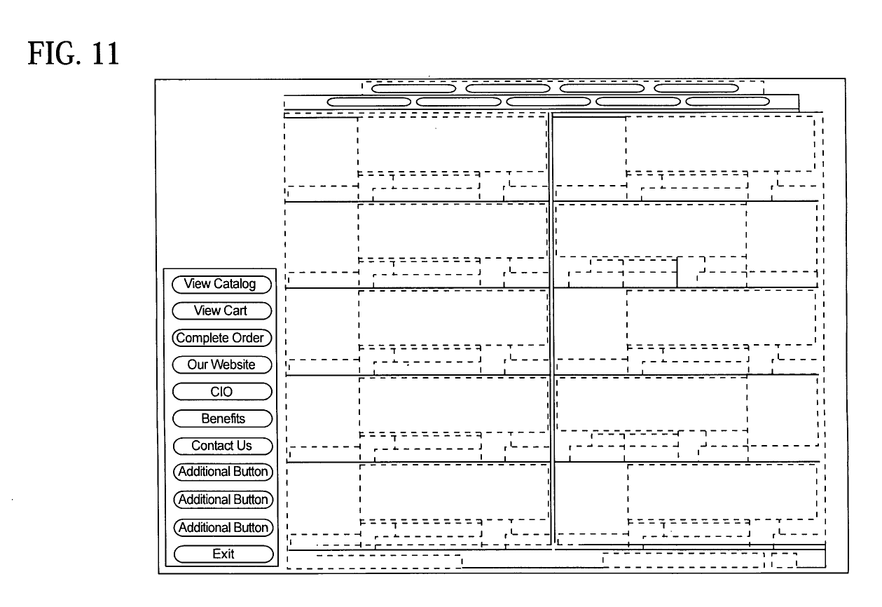

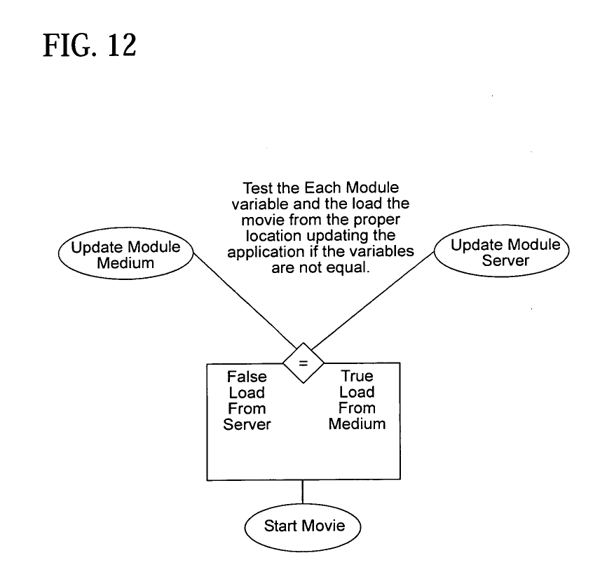

Module/Movie 3—Buttons, as shown in FIG. 11 this is the navigation control to the application. The buttons add or remove movies from the screen based on the user's interaction. Setting the visible property for each move to true or false and then calling functions stored in the proper movie completes the navigation.

Text Module of the UDC

Module/Movie 4—Text Display, this movie contains a field for loading text for display. The text field is designed to accept limited htmtags in the data to be displayed. These tags provide the ability to format the data in a visually appealing fashion.

Cart Module of the UDC

Module/Movie 5—Cart, the cart movie uses the cart array to display the products that the user selected from the catalog to purchase. The cart movie is made up of objects that are manipulated by code to display items ordered by the user. The movie preferably has a white background, an open area in approximately the top 40% of the screen where two page movies can be loaded. An ordered items dynamic text field is under the page load area. The page display also allows the user to increase the quantity of the item being ordered or to remove it from the cart. The cart movie also gathers the user information and transfers the order data to the client. The transfer of data can be as simple as an email to the company with the order information, to a data transfer to the company website and then opening a secure web page where the user can enter payment information.

Catlog Module of the UDC

Module/Movie 6—Catalog, as shown in FIGS. 1, 2 and 11 this module uses the information in the database to construct accurate visual displays. The catalog module has a load function for every page that will load the images and text from medium 20, update module 43 and/or server 30, update module 47. Each time a page is turned or a category is changed there are two calls to the load page function, one call for the left page and one call for the right page. Based on the database each field on the screen is loaded with data from the relational database, medium 20 and/or server 30. Update module 43 or 47 builds the data and the catalog module displays that data. The update module and catalog display module can be changed to add or remove fields, appearance of the data displayed or the functions and sizes of the pages.

Additional Modules Included in the UDC

Module/Movie 7—Email, this module gather information, creates an email message and then passes the email file to the Internet for delivery.

Module/Movie 8—Company Information, this module displays the company logo and contact information.

Module/Movie 9—Products, this is a large display of the product in the catalog.

The start movie is the background and three additional movies in this particular application are layered above it. This stacking effect show the integration of the individual movie layers into a seamless screen.

The description of the UDC and the process described herein is not limited to this one embodiment, but is employed to describe the developmental process and operational use of the present invention. It is understood that applications such as the UDC can be developed using alternative tools that employ the same or similar processes and that the UDC can be changed to create completely new applications. The description herein is not meant to limit the application of the method for updating a storage medium to a UDC or the current specific functions as this method can be employed with any audio, visual or other software application process.

Processing Steps Associated with the Load Module of the Present Invention

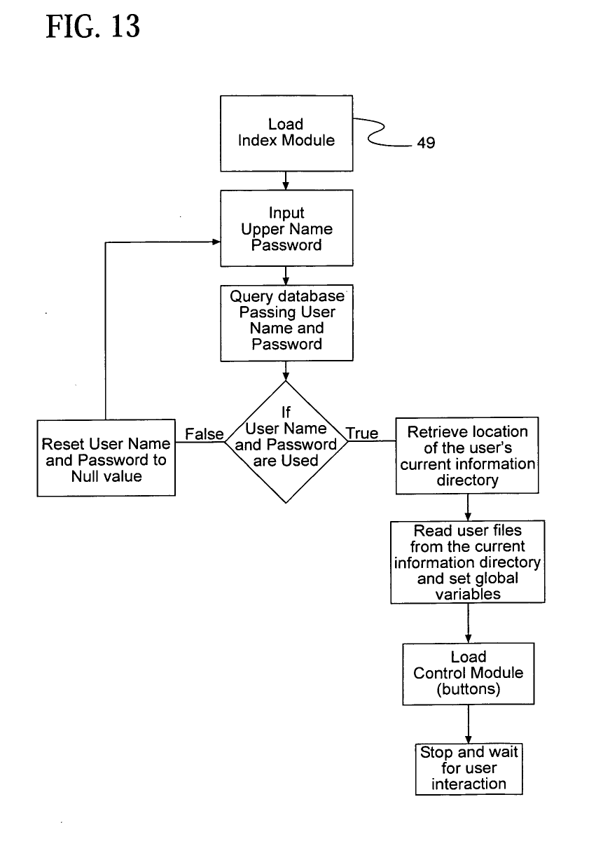

Referring now to FIGS. 1, 2, 3 and 13, load module 45 enables an authorized user to make changes to updateable application 47 on server 30 via external interface 37 or directly through user interface 32. Load module 45 can be used to change any type of information in application 47. Load module 45 can be used to change an image, for example, related to a category file 67 record without changing the related category detail file 68. In this instance, the photo version field value can be incremented without incrementing the category detail version field value. This same process can also be applied to the subordinate category detail field values without altering the version field of the corresponding category array. Load module 45 can only be accessed or used by authorized users. Upon the completion of a change it is immediately available to every updateable application 43.

Each updateable application 47 preferably has a unique load module 45 for updating that particular application. The method for updating a storage medium only allow a single authorized user access at any one time, but load module 45 can accommodate multiples authorized user access for simultaneous updating. Alternative versions of load module 45 can accommodate multiples authorized user access for simultaneous updating and use a single update module for different updateable applications 47 that are directed to each authorized user's respective update module 46 of updateable application 47.

Load module 45 provides the ability for application 43 to load an updated element such as an image, graphic, video or audio file as well as a program module, text field, string or character from application 47 at what is preferably the lowest level of file size in the relational database hierarchy and shortest download time from server 30. Load module 45 then integrates the updated element with one or more loaded elements from updateable application 43 on medium 20. Thus, rather than replacing a major portion or the entire application 43 for a given change, system for updating a storage medium 20 provides the ability to integrate updates from updateable application 47 on server 30 with application 43 for efficient dissemination through interface 12.

Load module 45 includes an index module 49 that functions as a holding module into which one or more functional component application modules 54 are selectively loaded with update module or current information directory 46. Index module 49 retrieves the location of update module 46 for updateable application 47 for that authorized user.

An important part of the process for updating a storage media is data management and the file naming convention. The management process of load module 45 assures that the data and images for any given data item is stored without inadvertently overwriting data or images for a different data item. This includes data integrity checks that can rename a given image file if the same file name is inadvertently repeated. The same naming convention is used for the texts files when necessary. This assures that the record being updated does not replace a file from a different record by mistake.

The files of updateable applications 43 and 47 use a naming convention that readily identifies them for correlating and then reading and comparing. In this preferred embodiment, the files of updateable applications 43 and 47 on medium 20 and server 30, respectively, use the exact same names. Load application 45 creates and updates the files using the category record number in the category file 67 to reference the correct record number in category detail 68. Load module 45 assigns the record location, version numbers, uploads text files, uploads and resizes image, graphic, video and audio, creates thumbnail images as required and assigns file names.

This process can be written in multiple Internet languages including php, asp, java, and Coldfusion. In one preferred embodiment, the entire application is designed using Macromedia Flash that executes Java script and Coldfusion to upload images, rename images, resize images and write text files. Flash also allows application design and interaction from the Internet. For example, from one Internet page an entire application can be added on demand and operated similarly to any application stored on a local computer. Image files are called by using Flash to call Java script, which in turn calls Coldfusion to upload the image file and then uses Java script to inform Flash that the upload was complete. The load module 45 process described is based on updating somename.txt files that will match the names to the files of updateable application 43

Preferably, access to load module 45 is granted only to authorized users. Load module 45 has three sections available in this one preferred embodiment using the UDC. In more complex applications, there may be more sections and in less complicated applications, there may be only one section. Each section is designed to address the updating of different aspects of updateable application 47. The first area is the Company Information. This section enables an authorized user to add, edit or delete the company information and the company logo. In one preferred embodiment, the company information section allows the user to move the location of the company logo, text, and change the background color. The second area is the category information. This section allows the user to add, edit or delete a category record as well as upload new images for the category opening pages and add or edit the text for the opening pages. In one preferred embodiment, the opening pages for each category can be removed and upon selecting a category, the user can immediately view the products. The third area is the product information. This section allows the user to add, edit or delete the category detail record. The authorized user can upload image files and edit any of the text fields related to a given product.

Preferably, the company information section updates the UDC update module 46. The information available for the authorized user to change includes company information, email and web address for links and the company logo. The ability of the authorized user in this or any section can be selectively limited. For example, in one preferred embodiment, the authorized user can only edit the above identified module fields because any changes to the modules can be programmatic and the user does not have access to the code to make changes to the module functions. However, it is understood that upload module 45 can include the authorization for authorized users to change any of the parameters of company information.

The company information section opens with the data fields displayed for editing. The user can at least edit this information. When the authorized user selects the appropriate field, the display fields are assembled and displayed for the user to review. The options, buttons, from this screen include standard buttons such as “Back” which returns to the input fields to make changes, “Cancel” which returns to the opening page without saving changes, “Save” which save the company information fields and “Next” which move to an upload page for the company logo.

A company logo load page is provided that allows the user to select an element of information such as a .jpg file from the files, displays that image for review and uploads the image to update module 46. The image is automatically resized to fit within approximately a 125 pixel by 125 pixels field within the one preferred embodiment of the UDC. The conversion preferably happens upon completion of the upload and is processed by server 30. Once the image is uploaded the file change is committed.

Processing Steps Associated with Managing the UDC

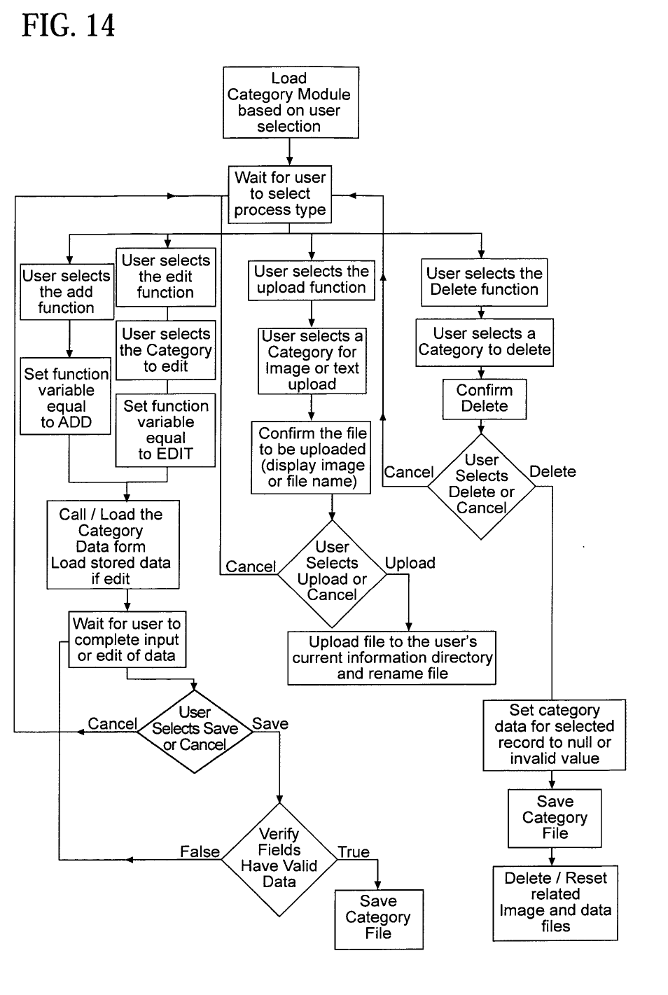

As shown in FIGS. 2 and 14, the category module allows the authorized user to delete, edit or add categories in the UDC. The category module accesses the category file and allows the user to change information contained therein. Upon saving the file, the saved changes are available for the catalog on a distributed media to access. In one preferred embodiment, a user may make changes and then access a transfer process to move the changes to a live CID directory. As a result, the catalog module allows users to edit the database over time and then provide these changes to all users at one point in time. In this preferred embodiment of a UDC, the categories are the tabs across the top of the catalog that correspond to a different group of products to the screen. Examples of categories include tires or batteries in which there can be one or more different products.

The Add Cateiorv Module of the UDC

Referring now to FIGS. 1,2,7, 14 and 15, to add a category, the authorized user selects the “View/Edit Category” button in the UDC. This results in additional buttons being displayed for the different editing category functions. The authorized user then selects the “Add Category” button to provide a place to enter the name of the category. After the category name is entered by the authorized user, the number of products per page section is displayed. The authorized user selects the desired number of products per page, 2, 3, 4 or 5, for example, and the available page layouts for those products per page are displayed for the authorized user to select. The authorized user then selects the page layout and identifies that it be positioned to the left page position of the UDC. This adds the page name for the selected page to the page A or left page field of the UDC in this preferred embodiment. Page B or the right page field of the UDC can be selected as described for the left page. The name of each page is also added to the page fields. The authorized user saves and stores the changes and can then return to Category Menu. At any stage in the process the previous steps are visible and available for being amended. No changes or adding to the record are stored until the add category is saved.

As an example of this, a graphic user interface screen that displays a “Name” and “Address” fields and needs to add a display field for “Phone Numbers”. The field can be added to the Name and Address graphic display screen on server 30 and the module containing that screen on distributable media 20 can be updated from the amended respective category array file 67 or category detail file 68.

A further example includes the adding of an image and text of a new version of a product, advertisement, image, video or audio track related to the existing product in that category file 70 of the UDC. The addition of any kind of file can include additional version tests. The above description holds true to all the different variations to the file and structures of array 67. The number of value tests can change and each value test can inform update module 46 to update the distributed media from a different location on the Internet or the distributed media 20. The locations on distributed media 20 can be assorted sub directories on server 30 that application 40 can load from different sub-directories within the current information directory or even completely different URL locations.

The Edit Category Module of the UDC

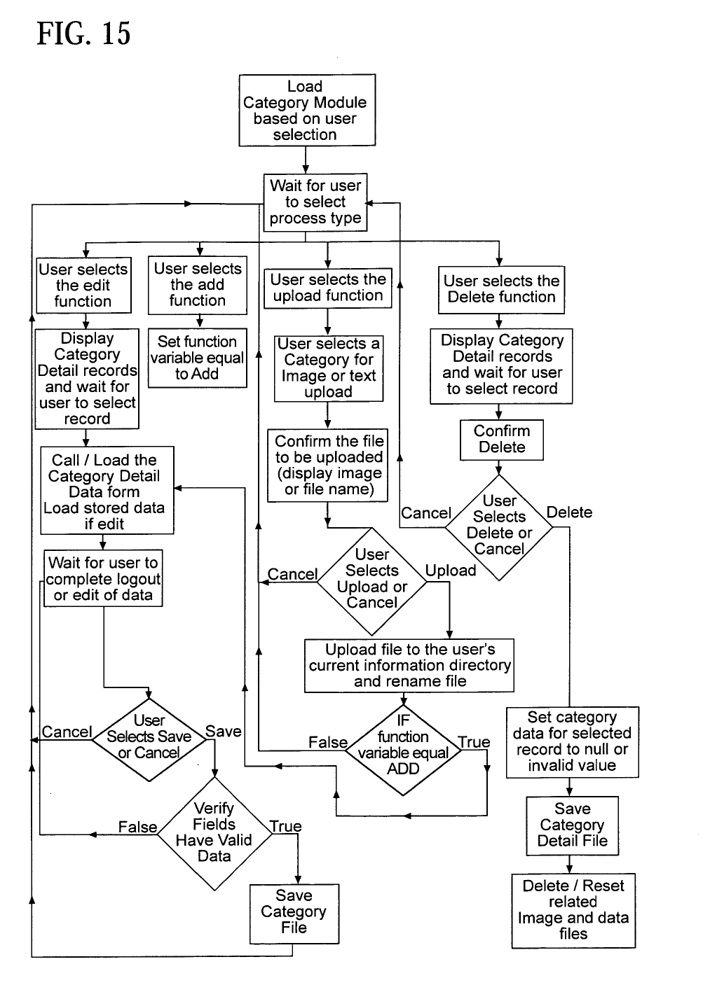

Referring now to FIGS. 1, 2, 14 and 15, the edit category requires the user to select a category for editing. If no category is selected an error message appears to inform the user to select a category to edit. The Edit Category process picks up on the last step of the Add Category process. All of the fields are filled with the values stored for the category. The user edits the fields they wish to change and saves the edit. If the user changes the number of products-per-page the application creates new thumbnail images of the products using the full size image.

In the preferred embodiment of the UDC, the full size image is approximately 350 pixels by 350 pixels. The thumbnail images for the catalog pages are approximately 85 pixels×85 pixels on 5 product-per-page, approximately 100 pixels×100 pixels on 4 product-per-page and approximately 150 pixels×150 pixels on 3 product-per-page. When the resize occurs, the authorized user saves each record in the category detail and the record's version is incremented. This will cause the catalog to find the version values on the medium 20 and update module 46 records to be not equal and the catalog will load all the images from server 30.

The updating of information in updateable application 47 can include editing text, image program modules, audio or video files. In addition, changes in information can also include changes in the interaction between two more data elements. An example of this would be the loading of video. Application video can be converted into and loaded in a frame-by-frame format. This allows the video to trigger additional data events at specific frames. A specific example can include a car race video clip that can be triggered to change advertisement images on one more of the vehicles in a different part of the application. Alternatively, if the audio that goes with the video was to name a product in a location outside the window containing the video, an image advertisement will be displayed.

Audio, as a form of data like video, can be automatically updated using load module 45. Additional presentation changes such as audio tracks can be added throughout the recording or inserted at specific locations in the performance. The audio and additional multimedia components can be updated every time or at predetermined intervals when medium 20 is played and connected to update module 46 of updateable application 47.

If the authorized user changes the category opening page or pages the related change is saved and the related version field is increment. The incrementing is only to the page version field. If new content is not uploaded the new page will appear with the old content. No action is taken in update module 46 to effect change until the authorized user saves the changes made at that time to the database. As necessary, the image sizes of the related category detail are changed and the category detail record is updated.

The Delete Category Module of the UDC

Continuing again with FIGS. 1, 14 and 15, the delete category is a simple three-step process. The category record is reset to “Delete” which will stop the category from being loaded by the catalog. The category detail record is reset and all images related to the category are deleted. The user selects the category to be deleted and the application informs the user that the category is about to be deleted and is given the option of continuing or canceling the process. “Continue” deletes the category and “Cancel” returns to the Category menu with any changes.

The Sort Module of the UDC

The authorized user can also reset the sort order for the categories at any time and thereby effectively renumber the sequence of the pages in the UDC. The sort order is from left to right with the bottom left tab being the first category and the top left being the sixth category in this preferred embodiment of the UDC. By using the sort order button the user can go to a page to set the categories to display across the top in any order they wish. To accomplish this, the user clicks on the “Category Sort Order” button. This brings the user to a page that displays the categories on buttons and a field above with a “Current Category” field above the category buttons. To change the sort order the authorized user selects the category to be moved and the name and identifying information of that category are moved to the Current Category. The user selects and repositions the category in the category list. The revised order is then saved to store the changes or cancelled, as desired.

Display Pages of the UDC

The section for uploading images and changing the text for the display pages is self-contained and loaded when selected by the authorized user. The authorized user selects a category for editing before clicking on the button or the application will prompt the user to select a category before it will continue. Upon opening the module displays, the two page format is selected for the category in this preferred embodiment of the UDC. Unlike the product pages in the UDC, the category left opening page preferably appear in the left position and the right opening page appears in the right position, this allows the user to continue the text message across the two page. The authorized user selects the page to be edited and then selects one of the desired editing function to continue the processing. The options include: “Cancel” which unloads the module and returns to the category menu, “Edit Text Only” Which moves to a page that displays the current information stored in the page record and allows the user to edit the information or “NEXT” which allows the user to upload an image in the same way the company information screen operated.

The Upload Page of the UDC

The upload page allows the authorized user to browse for an image to add to the page. In one preferred embodiment, upon the authorized user selecting a browse button and image file for upload, the load module 45 uploads the image to the server. The authorized user also may select a ‘Cancel’ option resulting in the authorized user being returned to a previous page to select another image. Once an image is selected and received on the server, the load module 45 resizes and renames the image. The load module 45 then loads the resized and renamed image into volatile memory for review by the authorized user prior to adding the image to the page. A similar technique for displaying images for review is performed by the company information module and category module.

Thus, load module 45 is used to provide informational changes to update module 46 and update module 46 changes as required in response to directions of when and where data is to be loaded from in the relational database into updateable applications 43 and 47. Whenever possible the data is loaded from storage medium 20 as this provides the fastest response time and limits the data required from the current information directory or update module 46. The process for updating a storage medium maintains a high performance level due to the limiting of the data loaded from updateable application 47 to information or programs that have been updated.

Processing Steps Associated with the Display Module of the UDC

Referring now to FIGS. 1 and 2, the operation of the display function of updateable application 43 as the UDC is now described. The display function of the UDC is started upon completion of the loading of update module 42 if only loading from medium 20 or update module 46 if loading at least partially from server 30. Update module 46 identifies the locations of the modules to be loaded, either from the media 20 and/or the server 30, and places the value in variables stored in base module 52. If there is not an external connection, update module 42 will load all of the application functions from the media 20.

Upon completion of processing the update module loads the display module (Module/Movie 6), the control module (Module/Movie 3) and company information (Module/Movie 8) the application process is then the update module is halted.

The Module/Movies being loaded are in themselves complete processes that function internally, interact with other module/movie and/or the base module and can have addition modules/movies loaded within themselves. Each Module can contain all or part of the following:
1. Initialization of location variables and loading initial data. This loading can be from a first operation default or can load data change based on the user interaction prior to loading the module or from the last time the user interacted with the module.
2. Functions to perform processes. These functions can be called from multiple locations within the module and the code is contain in one location to provide easy maintenance, and consistent performance.
3. Display elements. These elements can be images, video, or text field. The elements can be placed in a static location or can be created dynamically and placed for display based on variables or predefined parameters.
4. Control element. Buttons that are used to interact within the Module/Movie or to call functions or operation from other Modules that may be layered above of below the module/movie the user is interaction with.
5. Sound files that can be music, sound effects for buttons and/or audio to describe the functions of the module. These examples are not meant to limit the invention but to provide logical samples.

The above is intended to describe one preferred embodiment of the present disclosure and it not intended to limit other applications or embodiments.

Module/Movie 6, catalog is loaded. The Catalog module consists of content control tabs along the top of the display area, the category array is used to populate the content controls tabs. Next are two page layouts, a left and right page. These pages are used to display the category detail. And along the bottom of the display area from left to right are the page number for the left page, a dynamic text area for displaying messages, controls to flip to next or previous page(s), a second dynamic text area for displaying messages and the right page number.

When the Module/Movie is loaded for the first time the Category array is looped through and each category name is loaded into the content tab. The default value is set to the first category and the pages are loaded with the category detail data related to the category on the first content tab. The module halts and waits for user interaction.

Module/Movie 3, buttons, loads and displays the main control fuinction. This module/movie opens and waits for the user to select a function. In the UDC used to describe this invention this module has no initialization function so upon loading the module halts and waits for user interaction

Module/Movie 8, the company information. The module opens and performs an initialization process to populate the display areas. By reading data stored in the base module the company name, address and contact information is loaded. The module then loads the company logo based on a variable in the base module, this file can be loaded from the media or the server.

The UDC has now completed all of its predefined function and is waiting for the user to make a demand. The database, arrays, has been defined providing the location, media or server, of any subsequent images, audio, video or text data. The control buttons to access modules currently not displayed are visible and the catalog is open to the first content tab and the first two pages of data are displayed.

The user is now in control of the application and the data to be displayed. All controls that are visible, are functional and a user can select any button or control without the user having any special knowledge. The screen appears as one seamless presentation to the user. The user doesn't need to know about the layers or modules. All interaction should be transparent to the user.

To start the user interaction we will begin with the buttons module/movie 3. The user selects a function by clicking on the desired section. The button function performs the following steps:
1. Checks if the button selected matches the currently visible function. If the selected button matches the current display the function the fuinction exits without performing any action.
2. Checks if the selected application module(s) is loaded. If the module is loaded, hide, make not visible, any module(s) that is currently visible and not needed for the selected process. Then display, make visible, all modules that are needed to perform the selected process.
3. If the selected application module is not loaded, load the module(s) using the location stored by the update module in the base module.

Module/Movie 6, the catalog has many functions and modules that are loaded into it. The modules that are loaded at this level are the pages. These pages can be dynamically changed for each content tab, category. At the category level the Content Tabs, categories, along the top of the page all call the same function. The user selects a tab, the tab function call the Category change function passing the selected category.

The page number on the left is set to one and the page number on the right is set to two. The change category starts the page on the right flipping up. Upon completion of the flip up the page turn will start the left page turning down. During this process the first two pages of the category are populated for display. Giving the appearance of a page in a book turning.

The previous page button checks the value of the left page number field. If the value is one, the fluction exits and does not perform any flnctional changes. The display message area to the right displays a message stating that the user is on the first page. If the left page number is greater than one, the button fuinction subtracts two from the left and right page numbers then calls the previous page turn function. This function starts the left page flipping, turning, to the center, when the page reaches the top, being not visible the right page starts to flip, turn, down until it covers the page that was on the right. Again this gives the appearance of a page on a book being turned. While the page is turning, the pages to be displayed next are loaded.

The next page button checks the value of the right page number field. If the value is greater than a stored value for the maximum number of pages for the category, the function exits and does not perform any functional changes. The display message area to the right displays a message stating that the user is on the last page. If the right page number is less than the maximum number of pages, the button function adds two to the left and right page numbers then calls the next page turn function. This function starts the right page flipping, turning, to the center, when the page reaches the top, being not visible the left page starts to flip, turn, down until it covers the page that was on the left. Again this gives the appearance of a page on a book being turned. While the page is turning the pages to be displayed next are loaded.

For this example, there are six page display layouts or modules that can be loaded, each containing a single function that loads the category detail on the pages. The page display process is started by testing which side of the display, left or right, the page is loaded. Then using the matching page number, left for left and right for right, the page subtracts one from the page number then multiplies by the number of detail items to be displayed per page to create a start location variable for the lookup in the category detail array for display. (ie if the left page is one and there are four detail display section per page the start location would be zero, if the left page is number three the start location would be eight)

In the case of the UDC, the category detail record are individual products. The layout for the display consists of the fields to be displayed repeated for as many products that will be presented on the page. All fields have the same name and the difference for identifying the page location in a zero to the number of products on the page. (i.e., Product Image0, Product Image1, Product Image2) This convention holds true for all of the display fields.

After the starting location is calculated, the page display load function starts a loop from zero while the loop variable is less then the number of detail displays per page. For each cycle through the loop, the all fields are loaded based on the values stored in the category detail array these values can be actual variable values such as price of loaded information such as a product image from the media or server. On the first loop the data is stored in fields ending in 0, the second loop the fields will end in 1 and so on. The category detail array location is set by adding the loop number to the start location. If the start location is not less than the length on the selected category detail array the fields and labels for the product location are hidden, made not visible.

This page loading is perform simultaneously to the page being turned so that the user get the visual of the page turning and the page is being load so the upon completion of the turn the new data has been displayed and the user doesn't seem to have to wait for data.

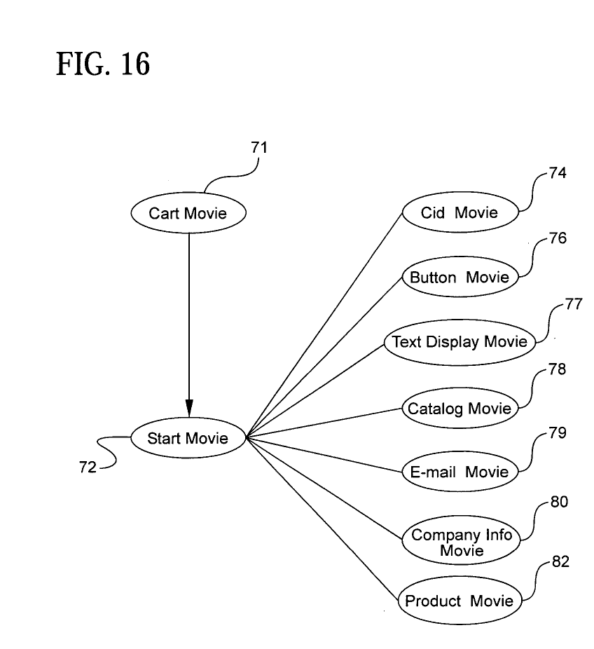

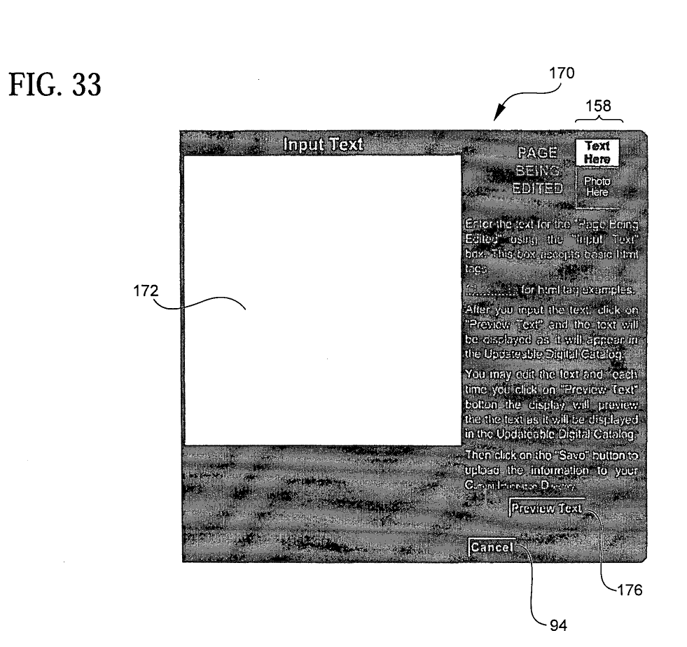

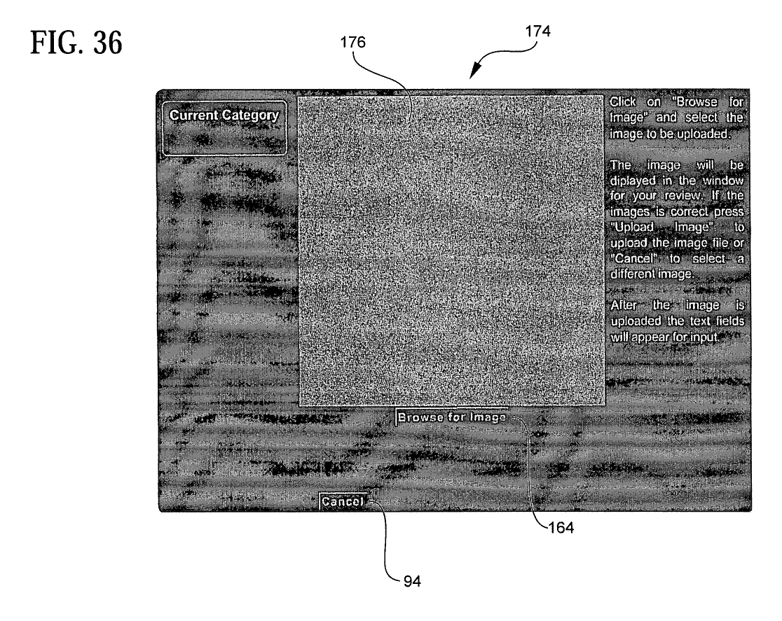

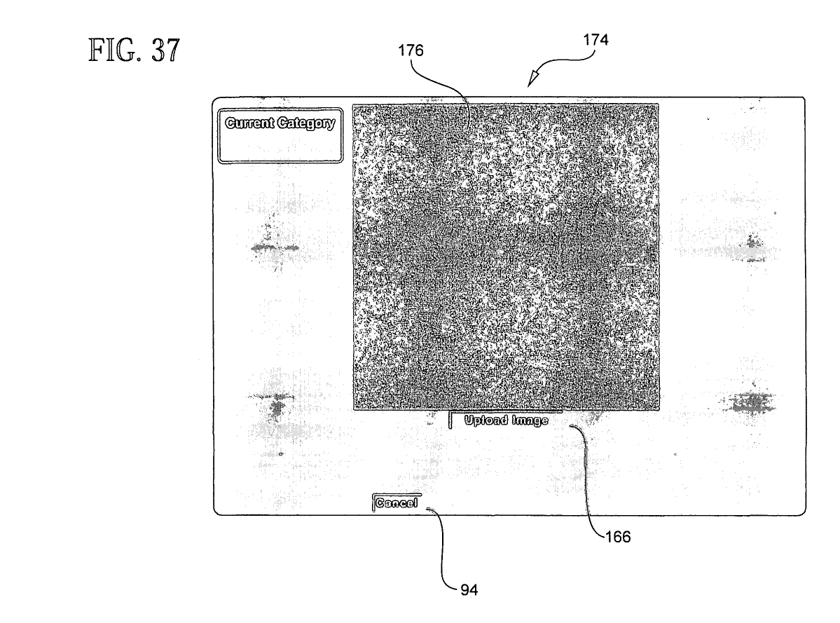

Referring now to FIGS. 16-38, a preferred embodiment of an updateable digital catalog using Macromedia Flash according to the present invention is disclosed. In Macromedia Flash, the base level is called a movie (for the purpose of this example the terms movie and module are interchangeably and both represent program modules that are assembled to create the application). Additional movies are then loaded in relation to this base movie. To further enhance visual effects, each movie may be configured with one or more levels within it.

For example, according to one preferred embodiment, as shown in FIG. 16, various layers of movies may be loaded. The movies include a start movie 72, a CID movie 74, a button movie 76, a text display movie 77, a catalog movie 78, an e-mail movie 79, a company-info movie 80 and a product movie 82.

As such, the first step is to design the application in modules/movies that can be loaded individually and yet interact with each other. Using the UDC as an example I will describe each module/movie.

The start movie 72 is the base of the application and provides the screen image in which all other modules are loaded. Preferably, the start movie 72 is read from the CD-ROM. The start movie 72 is loaded at level 0 and provides the background for the application. Preferably, the start movie 72 contains a rectangle the size of the movie screen and the necessary code to load the remaining application. In effect, the start movie 72 is a storage container and a movie screen on which the projector play the remaining movies.

The CID module 74 constructs the relational database for the application. The CID module may perform this construction in one of two ways. In a first way, the database is constructed using the Current Information Directory and the CD-ROM. The CID module 74 reads the files from both locations and then compares the data. Based on the comparison of the files, the CID module 74 constructs a series of arrays that are used to hold the current data and the location of any on-demand data. The on-demand data can be stored on the CD-ROM or the Current Information Directory.

The second way the CID module may construct the database is by using the CD-ROM only. For example, if access to the Internet is not available, the CID module reads only from the CD-ROM and points all on-demand content to the CD-ROM.

Preferably, the CID movie 74 includes only one visible field. The visible field is a text field that is used to inform the user that the CID movie 74 has updated the catalog and may be used to inform the user to log onto the Internet so that the catalog can be updated.

The CID movie 74 loads the master file to assign the location of the remaining movies to be loaded then it creates the datable and populates fields in the Start and Company Information movies. The CID module can be loaded from the CD-ROM or the Current Information Directory.

The overall process executed by the CID movie 74 is as follows: First, the CID movie 74 reads the CD-ROM master file and then using the CID ID, identifies the Current Information Directory URL on the Internet. Next, the CID movie 74 reads the CID file. After the read from the URL is complete, the CID movie 74 compares the data. Next, the CID module 74 loads the company name, address, city, state, zip, phone, fax and TollFree number from the Internet version in to the application for display. Next, the CID movie 74 tests the module versions set variables for the remaining movies pointing to the correct directory for loading, CD-ROM or Internet CID. The CID module 74 then creates the program resident database.

The button movie 76 provides navigation control to the application by providing user selectable push buttons. As such, the button movie adds or removes movies from the screen based on the user's interaction. Setting the visible property for each move to true or false and then calling functions stored in the proper movie completes the navigation.

The text-display movie 77 provides a field for loading text for display. The text field is designed to accept limited HTML tags in the data to be displayed. Preferably, the HTML tags provide the ability to format the data in a visually appealing fashion.

The cart movie 71 provides a shopping cart that can display products ordered. The cart movie 71 also provides a display that has two formats that appear simultaneously, a page format on the top and a text format on the bottom. The page format will display zero, one or two drop down boxes based on the product criteria. The drop down box is used to gather addition information about the product being ordered. For example, using the UDC as a clothing catalog, one box may collect the color and the other box may collect the size. Upon selecting a color or size, the text display is updated to show the new information. The page display also allows the user to increase the quantity of the item being ordered or to remove it from the cart.

The cart movie 71 also gathers the user information and transfers the order data to the client. The transfer of data can be as simple as an email to the company with the order information, or a data transfer to the company website and then opening a secure web page where the user can enter payment information.

The catalog movie 78 is the product display movie. The catalog module 78 uses the information in the database to construct accurate visual displays. In a preferred embodiment, the catalog module 78 has a load function for every page that will load images and text from the CD-ROM, the Internet Current Information Directory or both locations. Each time a page is turned or a category is changed there are 2 calls to the load page function, one call for the left page and one call for the right page. Based on the database, each field on the screen is loaded with data from the database, CD-ROM and or Current Information Directory.

The CID module 74 builds the data and the catalog module 78 displays that data. The CID module 74 and catalog module 78 can be changed to add or remove fields, appearance of the data displayed or the functions and sizes of the pages.

The e-mail movie 79 is a module that gathers information, creates an email message and then passes the email file to the Internet for delivery. The company information module 80 displays company logos and contact information and the product movie 82 provides a large display of the product in the catalog.

Of course, it will be appreciated by one skilled in the art that the description of the product and the process used herein is not limited to this one application but rather is used to describe the invention. In addition, the application can be changed in minor ways to create completely new applications. Furthermore, the description here is not meant to limit the UDC to the current fictions. The ideas and methods used to create this process are meant to provide freedom for applications to evolve. With this invention the evolution of the application can be instantly passed to all previous versions of the application in a seamless memory based model.

To begin execution of the UDC, the first step is to load the modules into MovieClips. The loading of MovieClips makes each loaded movie part of the movie containing the MovieClips. This has an advantage because unloading the movie that contains the MovieClips will also unload all the MovieClips contained by the base movie.

A second method is used to load movies on to levels above or below the base movie. Unloading one movie will not affect any of the movies loaded on other levels. It will be appreciated by one skilled in the art that there are both programmatic and logical reasons for the use of both methods.

In the example described, all of the movies are loaded using MovieClips with the exception of the cart movie 71, which is loaded to a level above the start movie 72.

An Internet update module is provided that allows the catalog owner to make changes to the catalog online and upon completing a change it is immediately available to every Updateable Digital Catalog the customer distributed.

As discussed previously, data management and the file naming convention are used throughout the system. In one preferred embodiment, the files on the CD-ROM and in the Current Information Directory use the exact same names. The Internet upload application creates and updates the files using a category record number in the Category file to reference the correct category detail record. This module then assigns the record location, version numbers, uploads text files, uploads image files, resizes image files, creates thumbnail of the images based on the number of products-per-page and assigns file names.

The Internet update module may assure that the data and images for any given product are stored without inadvertently overwriting data or images for a different product. For example, a client can upload a different image for each product, all named “Product.jpg” and the Upload Application renames the image file to “Cxx_xx.jpg” (“C” for category, first “xx” for the category number, “_” is a separator and the second “xx” is the record number.) The same naming convention may be used for the texts files when necessary and thereby assure that the record being updated does not replace a file from a different record by mistake.

In one preferred embodiment, the naming convention used for the category detail record is “Catxx_x.txt”. (“Cat” stands for category, “xx” is for the category, a number 1 through 11 and the second “x” is for the page, 1 for the left and 2 for the right).

The Internet upload application can be written in multiple Internet languages, such as, but not limited to, php, asp, java, and Coldfusion. For example, in one preferred embodiment, the entire application is developed in Macromedia Flash using calls to Java script and Coldfusion to upload images, rename images, resize images and write text files. Of course, it will be appreciated by one skilled in the art that other developmental tools may be used to code the Internet upload application.

### EXAMPLE

The example now described is based on updating somename.txt files that will match the names to the CD-ROM files. The update module described here is based on the UDC described as part of the CID Technology invention explanation above. The example is designed to show the editing and updating capability of the present invention.

The update module includes a logon screen where the user name and password are double verified for approval to an access module. The update module includes three sections, each including one or more graphical user interfaces that interface with other modules. Each section is designed to address a different area of the UDC.

The first section is the Company Information section. This section allows the user to add, edit or delete the company information and the company logo. The second area is the category information. This section allows the user to add, edit or delete a category record. Upload new images for the category opening pages and add or edit the text for the opening pages. The Third area is the product information. This section allows the user to add, edit or delete the category detail record. The user can upload image files and edit any of the text fields related to the product.

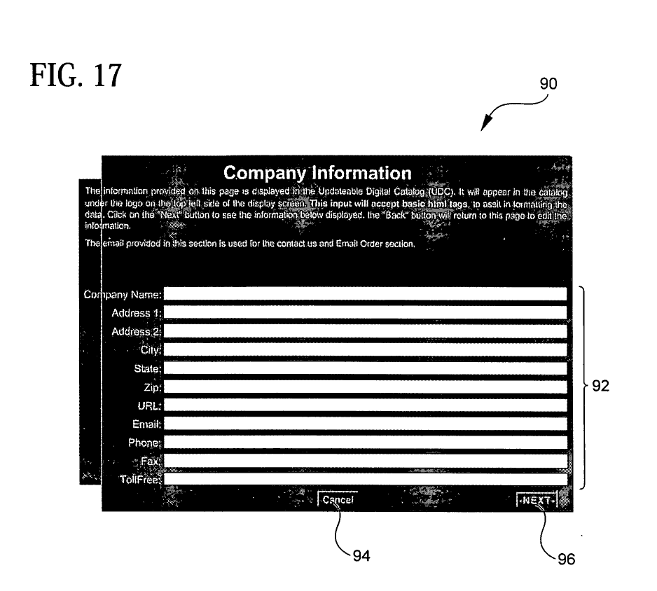

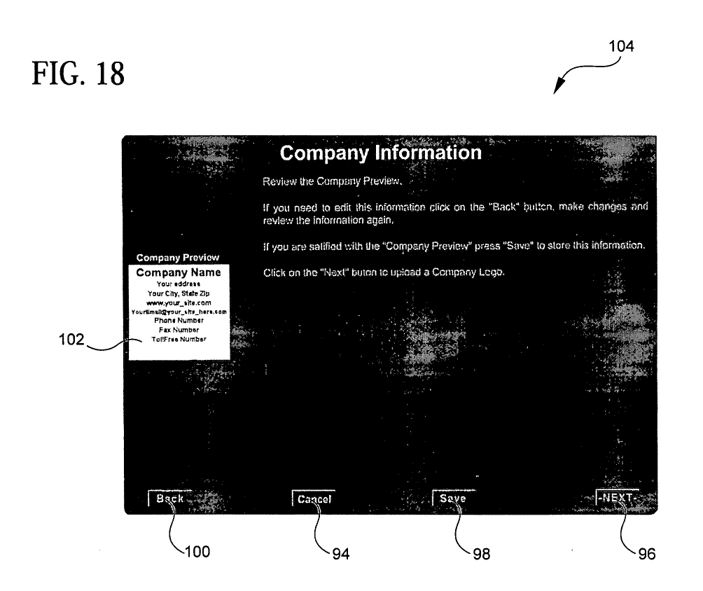

For example, referring now to FIGS. 17 and 18, company information graphical user interfaces 90, 104 are shown that allows a user to update company information, and thereby, the UDC Master file. As shown in FIGS. 17 and 18, various information fields 92 are provided for the user to edit, such as the company information, email and web address for links and uploading the company logo. In one preferred embodiment, functionality is provided to the user to select a background color, a button color and adjust the position of the company logo and text display.

Preferably, the initial company information user interface 90 opens with the data fields 92 displayed for editing. The user can edit the information. By clicking on the “NEXT” button 96 the display fields are assembled and displayed for the user to review.

For example, as shown in FIGS. 17 and 18, selectable user options include a “Back” button 100 which returns to the input fields to make changes, a “Cancel” button 94 which returns to the opening page without saving changes, a “Save” button 98 which saves the company information fields and a “Next” button 96 which move to an upload page for the company logo.

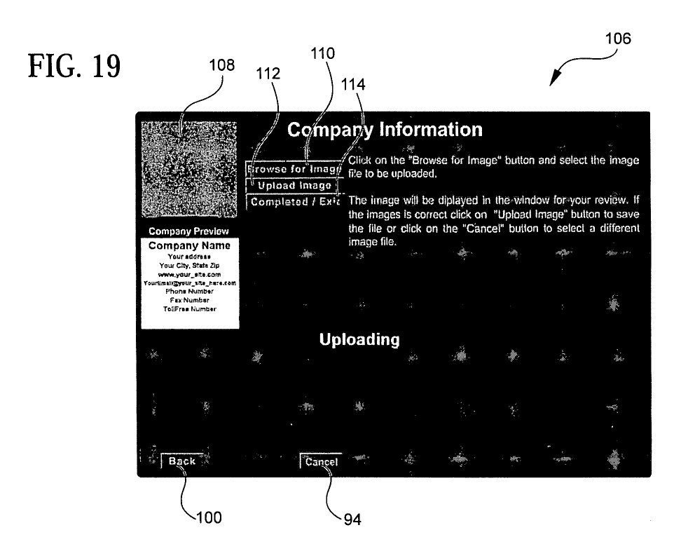

Referring now to FIG. 19, a company logo upload page 106 is provided that allows the user to select a JPEG file from stored images using a “Browse” button 110. Upon selection, the selected image is displayed in a preview area 108. The upload page 106 also allows the user to upload the image to the current information Directory upon selection of an “Upload” button 112. The user also may exit the upload page 106 upon selection of the “complete” button 114.

In one preferred embodiment, the image is automatically resized to fit in the preview area 108. For example, in one preferred embodiment, the preview area is a 125 pixel by 125 pixels. Of course, it will be appreciated by one skilled in the art that it does not matter what the size of the images are being previewed since the conversion happens upon completion of the upload and is processed by the server.

Once the image is uploaded, in one preferred embodiment, the file change is committed and may not be reversed. To change the image again, the user may have to repeat the upload process.

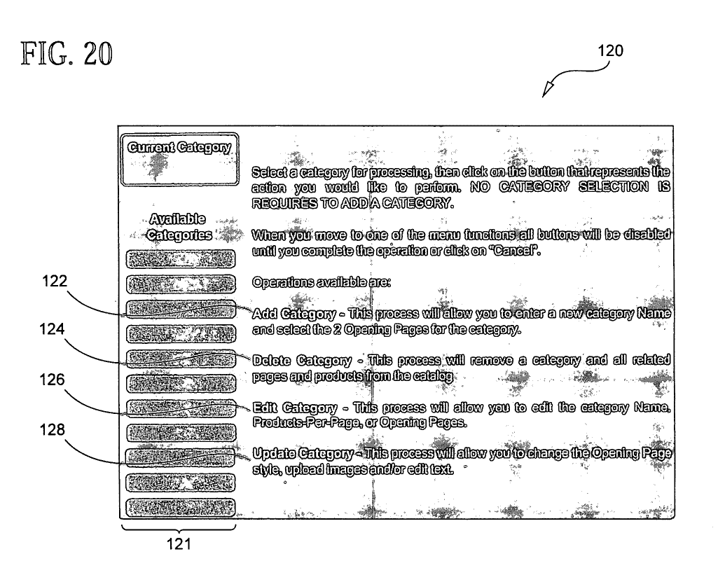

Referring now to FIG. 20, an example graphical user interface for providing category functions according to the present invention is shown. As shown in FIG. 20, a category user interface 120 is provided that allows the user to delete 124, edit 126, update 128 or add 122 categories in the UDC. The categories are the tabs 121 shown on the left side of the interface 120. Each tab delivers a different group of products to the screen.

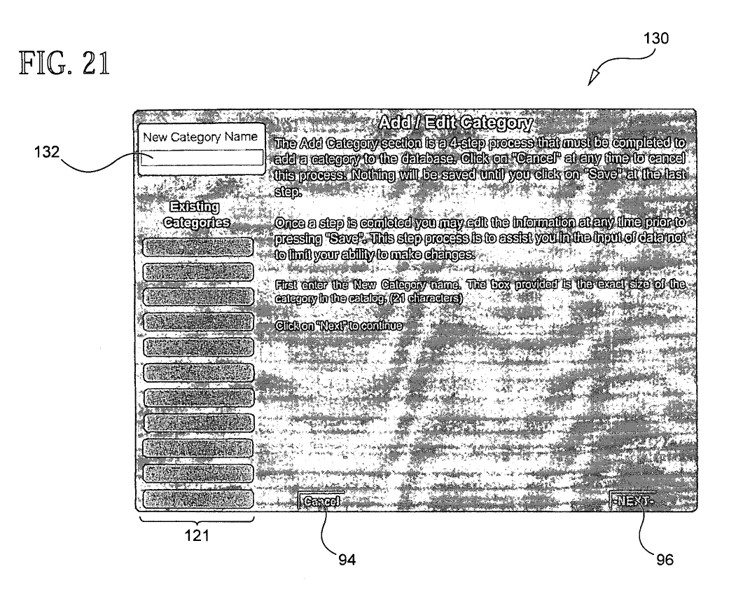

For example, referring now to FIG. 21, a graphical user interface 130 for adding a category to the database is shown. As shown in FIG. 21, a category name field 132 is provided where the user enters the name of the category to be added. After the user enters the category name, they select the “NEXT” button 96 and a number of products per page section 138 is displayed.

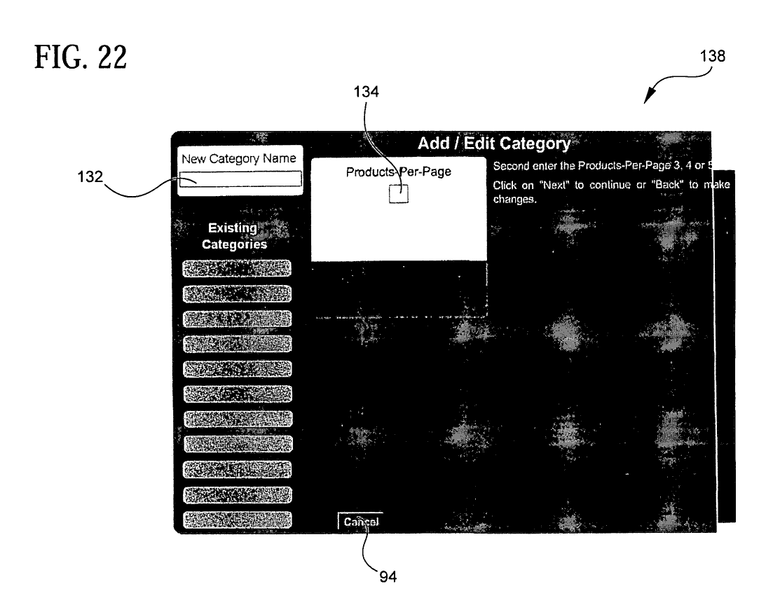

Referring now to FIG. 22, a graphical user interface 138 for entering the number of products to be displayed on a catalog page is shown. As shown in FIG. 22, a products-per-page input field 134 is provided that allows the user to specify a number of products (e.g., 3, 4, or 5) that are to be displayed on each catalog page. Upon entering a product number, a page layout user interface 138 is displayed.

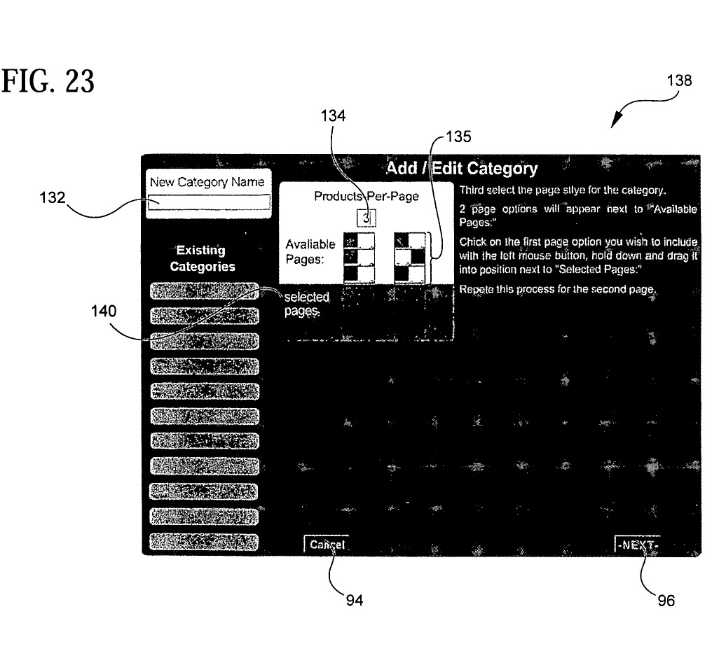

Referring now to FIG. 23, the page layout user interface 138 allows the user to select available page layouts for the product. For example, as shown in FIGS. 23, the user may select a page layout 135 with the left mouse button and hold down the button. The user may then drag the page layout to the left page position 140 thereby adding the page name for the selected page to the pageA field.

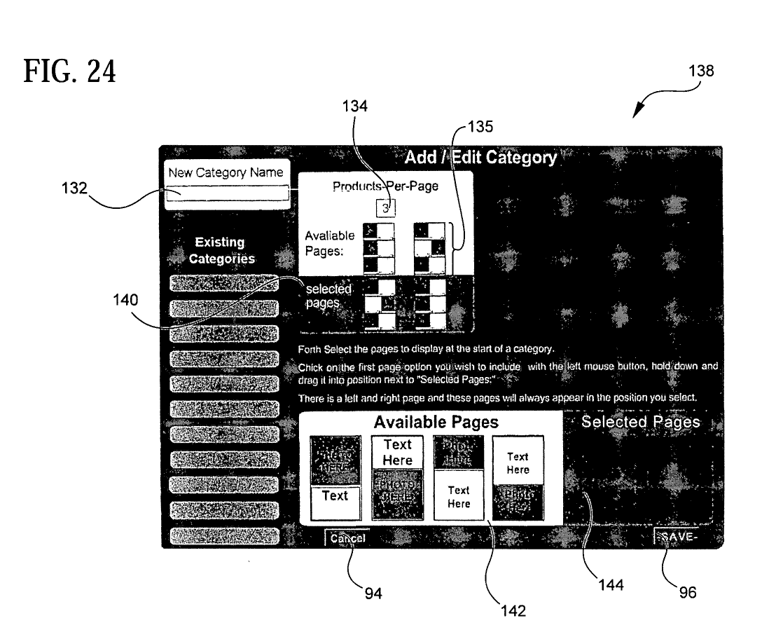

Referring to FIG. 24, the page layout user interface 138 also allows the user to drag the page layout to the right page and thereby add the page name to the pageb field.

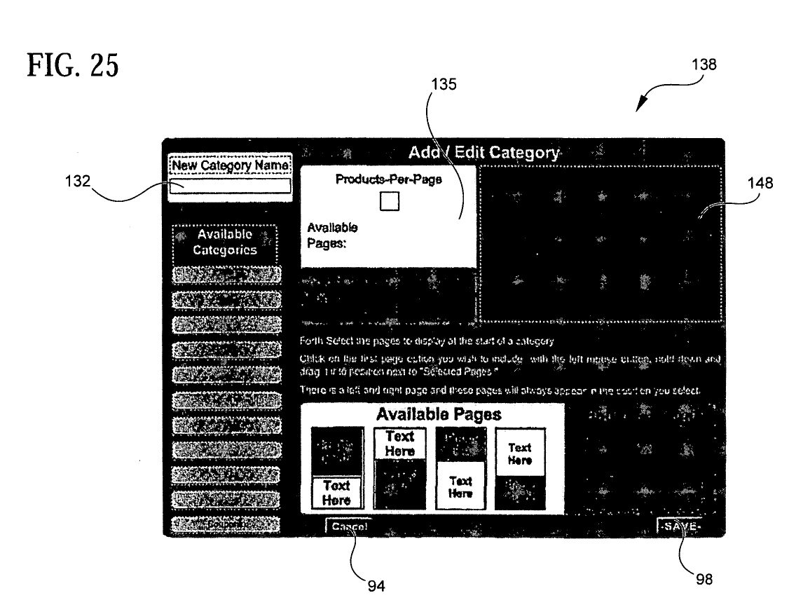

Referring now to FIG. 25, upon selection by the user of a page layout and selection of the “Save” button 98, the page layout user interface 138 provides open page options to the user. The open page options are displayed and similar to the drag a page layout to the left and right position described previously, this places the page names in OpageA and OpageB fields. Upon selection of the save button 98, any changes made are stored and the user is returned to the category user interface 120.

It will be appreciated by one skilled in the art that at any stage in the process, the previous steps are visible and available for editing. No changes or Adding the record are stored until the “Save: button is clicked.

The Edit Category requires the user to select a category for editing. If no category is selected an error message appears to inform the user to select a category to edit.

Referring to FIG. 25, the Edit Category follows the last step of the Add Category process. All of the fields are filled with the values stored for the category. The user edits the fields they wish to change and selects the “Save” button 98.

In one preferred embodiment, if the user changes the number of products-per-page the application creates new thumbnails of the products using the full size image.

For example, in one preferred embodiment, if the full size image is 350 pixels by 350 pixels, the thumbnail images for the catalog pages are 85 pixels×85 pixels on 5 product-per-page, 100 pixels×100 pixels on 4 product-per-page and 150 pixels×150 pixels on 3 product-per-page. Using the full size image may produce a better quality image than resizing the existing image.

When the user-resizes an image and selects the “SAVE” button 98, each record in the category detail record's version is incremented. This causes the catalog to find the version values on the CD-ROM and CID records to be not equal and the catalog will load all the images from the CID.

If the user changes the category opening page or pages the related change is saved and the related version field is increment. The incrementing is only to the page version field. If new content is not uploaded the new page will appear with the old content.

Preferably, no action is taken by the system to effect change until the user selects the “SAVE” button 98 at that time the database changes are made. If necessary the image sizes of the related category detail are changed and the category detail record is updated.

Preferably, the delete category is a three-step process. Once a category is deleted it may not be reversed. The Category record is reset to “Delete” which inhibits the category from being loaded by the catalog. The category detail record is reset and all images related to the category are deleted.

The following steps may be executed by the user to delete a category:

1. The user clicks on the category to be deleted
2. The user clicks on a “Delete Category” button
3. The application goes to a screen that informs the user of the category about to be deleted and is given the option of continuing or canceling the process. “Continue” deletes the category and “Cancel” returns to the Category menu with any changes.

The user can reset the sort order for categories at any time. The sort order is from left to right with the bottom left tab being the first category and the top left being the sixth category. The reasoning behind this is to set the category for less than 6 categories only to display the bottom row of tabs.

By using the sort order button the user can go to a page to set the categories to display across the top in any order they wish. To accomplish this the user selects on the “Category Sort Order” button.

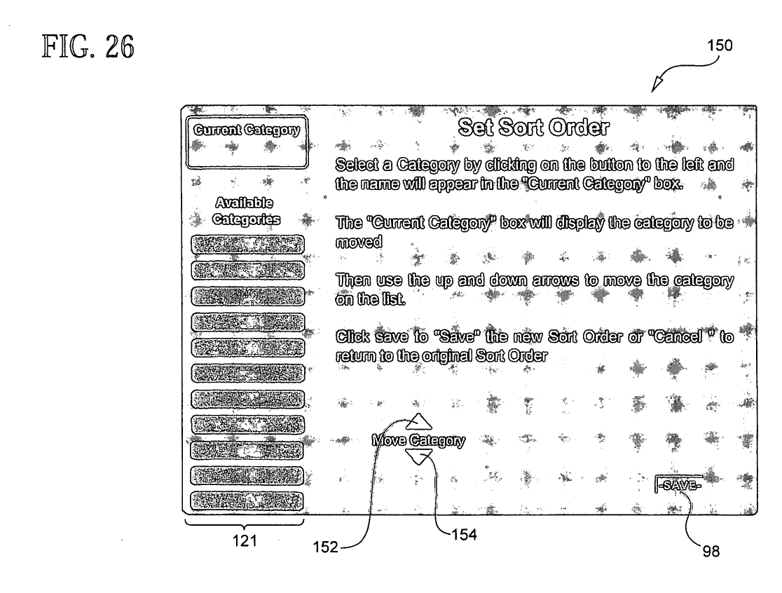

Referring now to FIG. 26, upon selection of the “Category Sort Order” button, a graphical user interface 150 is displayed that may be used to reset the sort order for categories at any time. The user interface 150 displays the categories on buttons 121 and a “Current Category” field above the category buttons. Along side of this grouping are two triangle buttons 152, 154 one pointing up 152 and the other pointing down 154. Between these buttons is the word “Move”.

The following steps will change the sort order:

1. The user selects on the category that is to be moved. Upon releasing the mouse button over the category the name and id are moved to the Current Category.
2. The user clicks on the up or down triangle button and the category will move up or down in the category list.
3. The user click on “Save” to store the changes or “Cancel to discard the changes.

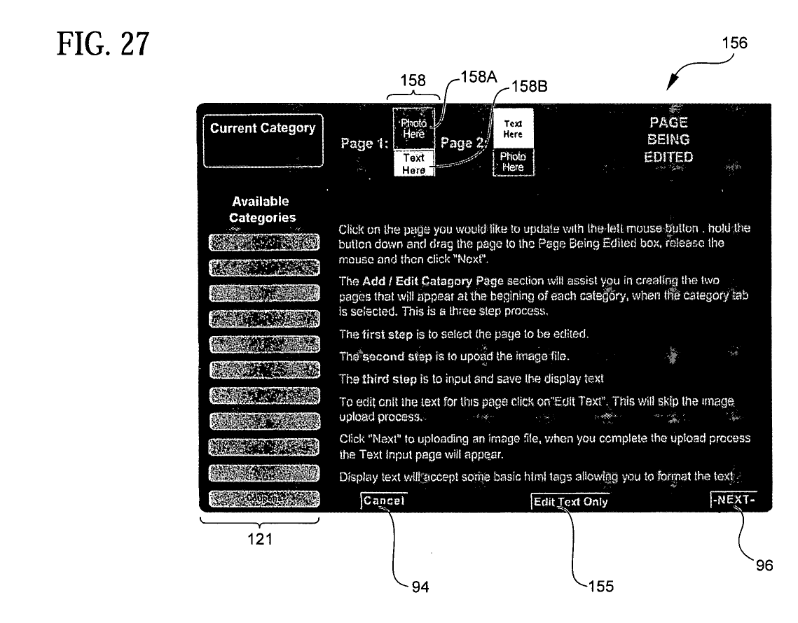

Referring now to FIG. 27, a graphical user interface 156 for uploading and editing display pages is disclosed. Preferably, this section is a self-contained module that is loaded when the user selects on an “Upload/Edit Display Pages” button. Preferably, the user selects a category before selecting on the button or the application prompts the user to select a category before it continues.

Upon opening, the module displays the two page formats selected to the category. Unlike the product pages in the UDC, the category left opening page appears in the left position and the right opening page appears in the right position. This allows the user to continue the text message across the two pages.

The user selects the page to be edited by clicking the left mouse button on the page to be edited and holds it down while dragging the page to the “Page Being Edited” box. The user then selects one of the shown buttons to continue the processing.

For example, as shown in FIG. 27, the button options are: “Cancel” 94 which unloads the module and returns to the category menu, “Edit Text Only” 155 which moves to a page that displays the current information stored in the page record and allows the user to edit the information or “NEXT” 96 which allows the user to upload an image in the same way the company information screen operated.

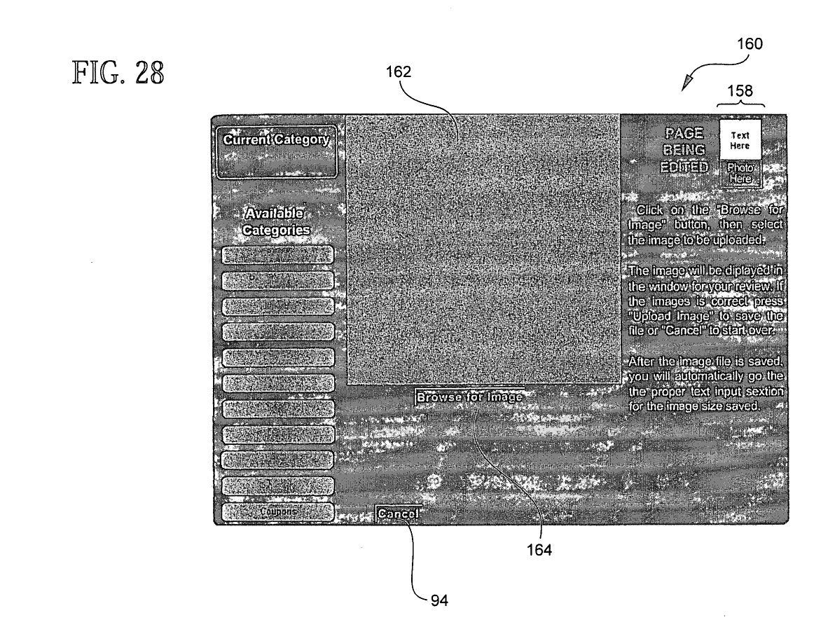

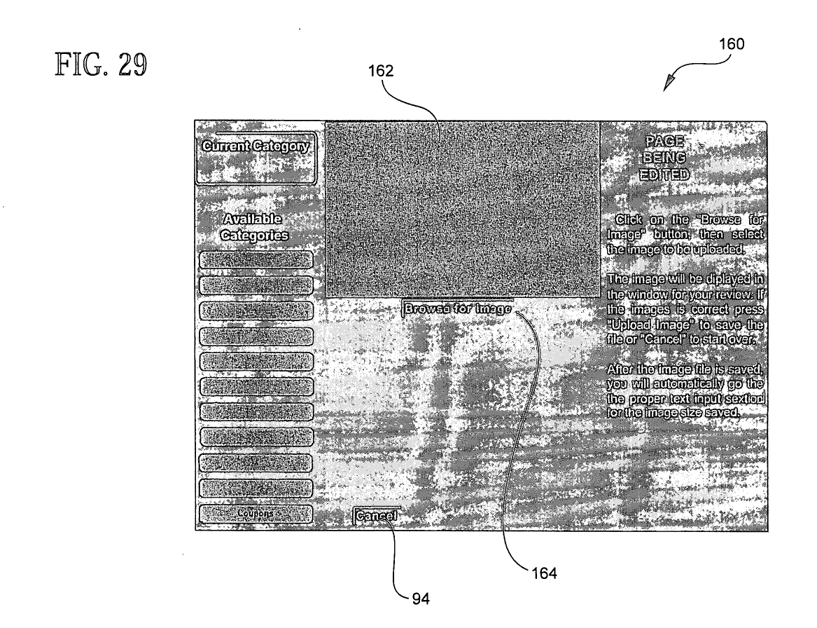

Referring now to FIGS. 28 and 29, an upload graphical user interface 160 includes a box 162 that allows the user to browse and preview an image to add to the page. For example, selection of the “BROWSE FOR IMAGE” button 164 allows the user to select images for viewing in the box 162.

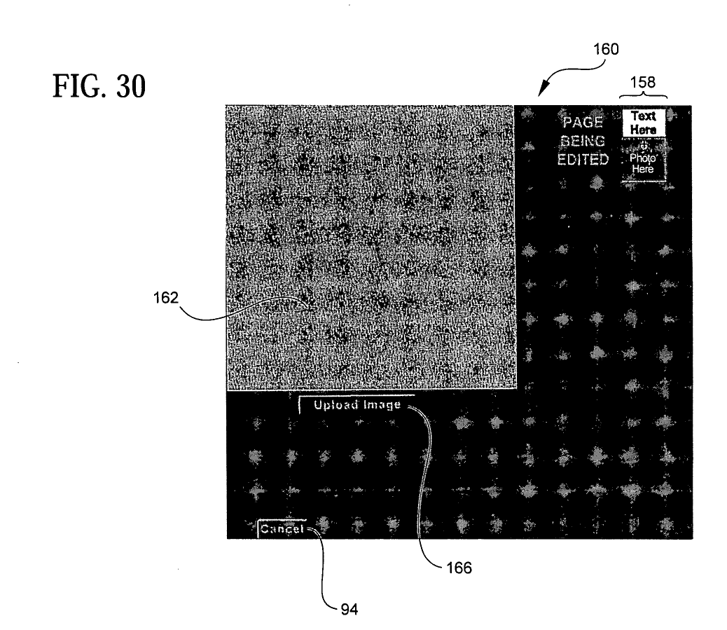

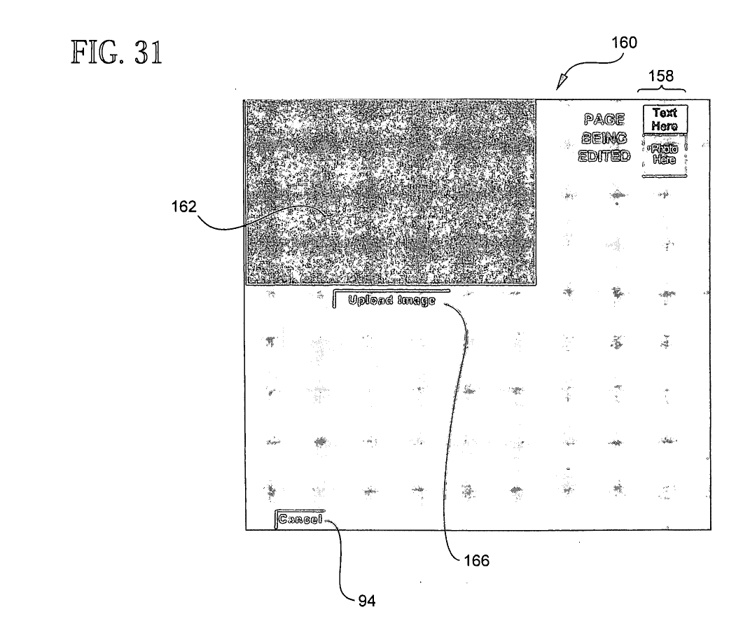

After the user selects the image to be uploaded, the application displays the image for review. The user has a chance to review the image. As shown in FIGS. 30 and 31, the user can upload the image by selecting an “upload image” button 166 or press the cancel button 94 to return to the previous page to select a different image.

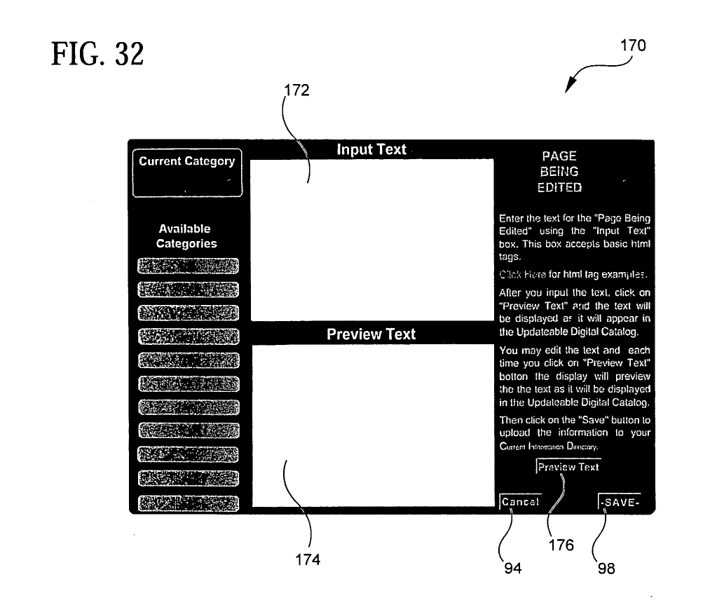

Referring now to FIGS. 32, 33 and 34, upon the completion of the upload, the proper text input page 170 is displayed. As shown in FIG. 32, the user may enter the text for the page being edited using an input box 172, Preferably, the input text box 172 accepts basic HTML tags. Once entered, the user may select a “Preview Text” button 176 and the text is displayed in a preview area 174. Selecting the save button 98 then saves the text to the current information directory.

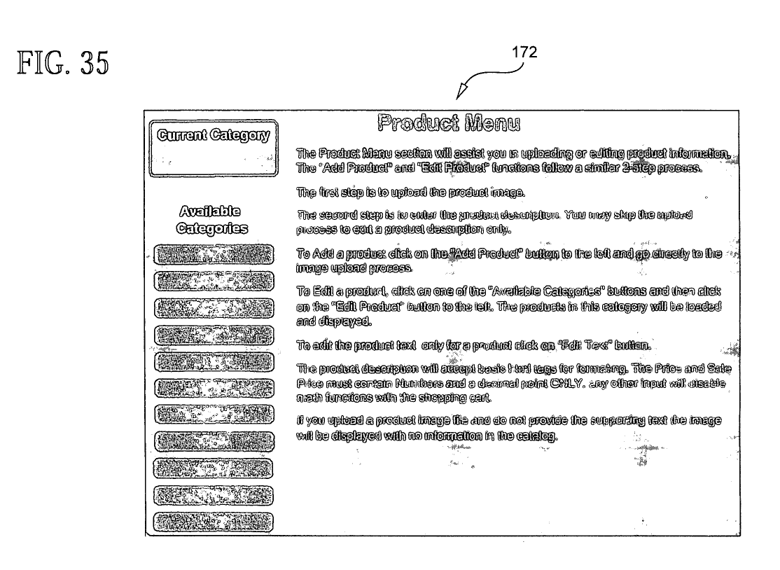

Referring now to FIG. 35, a product menu screen 172 is disclosed. Preferably, the product menu screen 172 is accessible from the first button on the main menu because as options may be used most often with the remaining buttons in order to add and/or modify Category and Company Information.

The product menu screen 172 allows the user to add, edit and delete products in the category detail files. Preferably, each category has it own file that is designed to accept approximately 100 records. Of course, it will be appreciated by one skilled in the art that that the UDC and the Upload module may be designed to contain more records.

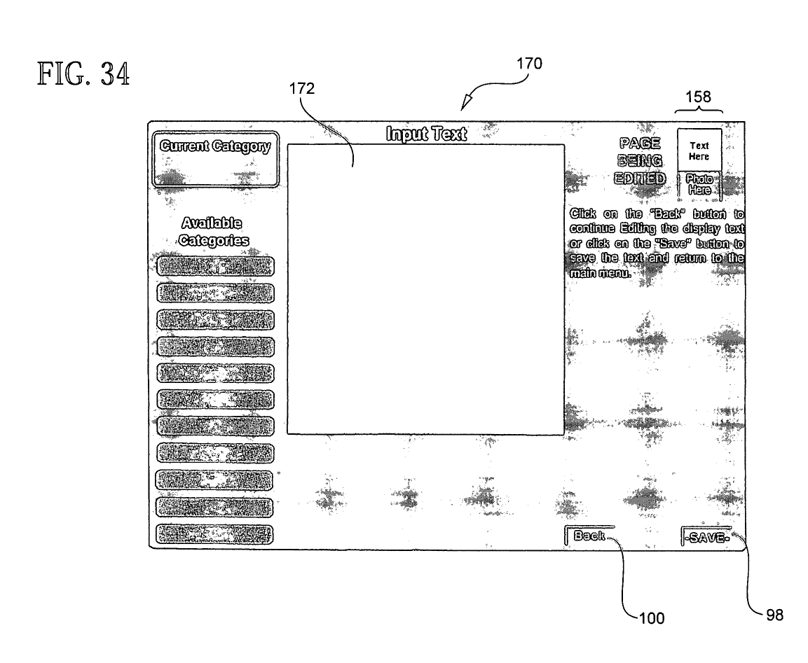

Preferably, the product module automatically resizes images to meet the size set in the product-per-page field in the related category. The display for inputting and editing text also match the appearance of the product display 158 in the UDC thus allowing the user to see exactly how the image will appear in the UDC. As shown in FIG. 34, the user may select the back button 100 to continue editing the display text or the save button 98 to save the text and return to the main menu. Preferably, before the user can add, edit or delete a product, a category is selected. Upon selecting the category the necessary variables to perform the function are loaded.

Referring now to FIGS. 35, 36 and 37, after selecting a category for adding a product, the upload module loads the category detail field and moves to the upload screen 174. This screen 174 works similar to the Company Information and Category image upload screens. The user selects the file to be uploaded by selecting the “Brose for Image” button 164 and the image is displayed for the user in a display area 176 to review and the image is uploaded and resized. In one preferred embodiment, the image is resized to 350 pixels by 350 pixels.

In one preferred embodiment, this process has two additional steps in the upload process. The first is to create a thumbnail of the image that fits with the bound of the images size set by the products-per-page fields in the category file. For example, in one preferred embodiment, the thumbnail images for the catalog pages are 85 pixels×85 pixels on 5 product-per-page, 100 pixels×100 pixels on 4 product-per-page and 150 pixels×150 pixels on 3 product-per-page. Using the full size image will produce a better quality image than resizing the existing image.

The second step is to move to a screen and display the image and the fields in the same layout of the catalog. The text input/edit page is select based on the category products-per-page field.

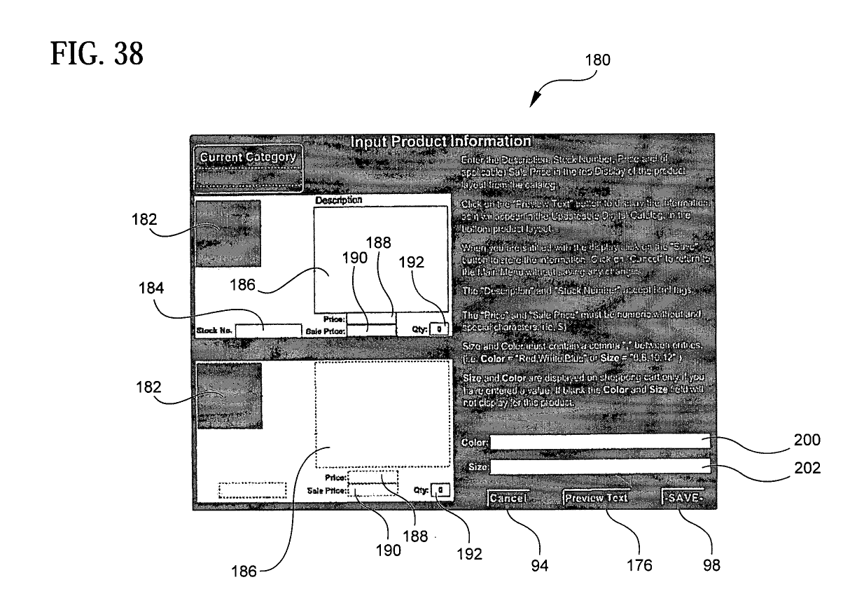

Referring now to FIG. 38, an input product information screen 180 is disclosed. As shown in FIG. 38, the user may enter a description of the product into a description area 186, Stock Number 184, Price 188, and Sale Price 170 if one is applicable. Then selecting on the “Preview Text” button 176 the information is displayed in the product layout format as it will appear in the catalog. This allows the user to use htmltags like <b></b> for bolding text. The input product display shows the tags but the preview product display 182 shows the text in bold without showing the tags.

There are two additional fields for the product in the example of the UDC in this example, Size 202 and Color 200 fields. If data is placed in these fields the UDC will display a drop down box in the cart movie and populate them with the items in these fields. If there is no input in these fields, the drop down box is not displayed in the cart. Preferably, the items are input with a “,” delimiter. The system does not impose a limit on the number of items but preferably the fewer the options the easier it is for the consumer.

To edit a product, the user selects a category and selects an “Edit Product” button. The application loads the category detail file for the selected category and then displays the products using the image and stock number 184. The user selects on the product to be updated and then selects an option button. The options are: “Cancel” 94 which returns to the product menu and “Edit Text Only” which moves to the proper page based on the products-per-page and displays the information for the user to edit and “Next” which moves to the upload section and guides the user through changes such as the add process.

To delete a product, the user selects a category and selects a “Delete Product” button. The application loads the category detail file for the selected category and then displays the products using the image and stock number 184. The user selects on the product to be updated and then selects an option button. The options are: “Cancel” which returns to the product menu and “Next” which moves to a page displaying the product to be deleted, allowing the user to “Cancel” the delete or select “Next” to commit the delete.

The description of the system and the methods described herein of the present invention are not limited to this one embodiment of the UDC, but the UDC has been employed to describe the developmental process and operational use of the present invention. It is understood the present system and method can be employed in purely audio applications, multimedia applications including images, graphics and video as well as combinations thereof. It is further understood the UDC as an application can be developed using alternative tools that employ the same or similar system and/or method. The description here is not meant to limit the application of the method for updating a storage medium to a UDC or the current specific functions as this method can be employed with any audio, visual or other software application process.

What is claimed is:

1. A method for updating information of a distributable storage medium that is coupled to a medium reader of a computer, the method comprising the steps of:
connecting a computer to a server;
reading a status of files of a first updateable application on a distributable medium and a status of files of a second updateable application on the server;
comparing the status of the files of the first updateable application to the status of the files of the second updateable application;
identifying updated files of the updateable application on the server;
transmitting selectively the updated files to a database in the volatile memory of the computer;
integrating the updateable application on the distributable storage medium with the updates from the updateable application on the server in volatile and non-volatile memory,
wherein the distributable medium includes a recording of the first updateable application and the server includes a recording of the second updateable application.

2. The method of claim 1, further comprising constructing a relational database in the volatile memory of the computer.

3. The method of claim 2 comprising populating the relational database with values identifying the name and location of the updated files and field values to be loaded by the application.

4. The method of claim 1 further comprising:
loading a predetermined amount of information initially into the volatile memory; and loading the remaining information on demand of the user.

5. The method of claim 4 comprising loading a load module connected to the updateable application on the server into the volatile memory, the load module adapted to change information of the second updateable application.

6. The method of claim 1 comprising storing the updated information in the volatile memory of the computer for dissemination.

7. A method for updating a distributable storage medium coupled to a computer that includes a distributable storage media reading device, the method comprising the steps of:
connecting a computer to a server;
reading a status of files of a first updateable application recorded on a distributable storage medium and a status of files of an updateable application recorded on the server using an update module of the first updateable application;
comparing a status of the update module of the first updateable application on the medium to the status of an update module of the second updateable application on the server;
identifying changes in the status of the update module of the second updateable application on the server;
replacing the update module of the first application with the update module of the second application that includes changes in the volatile memory of the computer;
reading the status files of the updateable application on the medium and the status of the files on the server;
identifying updated files of the updateable application on the server;
transmitting the updated files to a database in the volatile memory of the computer;
integrating the updateable application on the distributable storage medium with the updated information from the updateable application on the server in volatile memory; and
disseminating the information of the updatable application on the distributable medium with the updated information from the updateable application on the server.

8. The method of claim 7 comprising constructing a relational database in the volatile memory of the computer.

9. The method of claim 8, comprising populating a category array of the relational database with values identifying the name and location of the files to be loaded by the first updateable application.

10. A method of updating information recorded on a storage medium comprising:
comparing a first file associated with a first application included on a distributable storage medium of a first computer with a second file associated with a second application on a server, the first file and second file being at least one of a data file and a program module;
constructing a database in volatile memory of the first computer, the database including information on the location of at least one of the first file and second file to load into the volatile memory based on the comparison; and
disseminating information associated with the at least one first and second file using the database in response to a user request.

11. The method of claim 10, wherein the comparing comprises establishing a network connection between the first computer and the server.

12. The method of claim 10, wherein the database is a relational database.

13. The method of claim 10, further comprising removing the database from the volatile memory in response to a user request.

14. The method of claim 10, further comprising loading automatically a partial amount of information from the first application into the volatile memory of the first computer.

15. The method of claim 14, further comprising loading on demand a portion of the information into the volatile memory of the first computer in response to a user request.

16. The method of claim 10 wherein the data file is at least one of an image file, a video file, a graphic file, and an audio file.

17. A system comprising:
a computer network;
a server coupled to the network; and
a first computer device coupled to the network and a medium reader for a distributable storage medium, the first computer device including a processor and volatile memory configured to include memory storing instructions that, in response to receiving a request for access to a service, cause the processor to:
compare a first file associated with a first application included on the distributable storage medium of the first computer with a second file associated with a second application on the server, the first file and second file being at least one of a data file and a program module;
construct a database in the volatile memory of the first computer, the database including information on the location of at least one of the first file and second file to load into the volatile memory based on the comparison; and
disseminate information associated with the at least one first and second file using the database in response to the request.

18. The system of claim 17 wherein the memory stores instructions that, in response to receiving the request, cause the processor to generate a relational database.

19. The system of claim 17 wherein the memory stores instructions that, in response to receiving the request, cause the processor to remove the database from the volatile memory in response to a user request.

20. The system of claim 17 wherein the memory stores instructions that, in response to receiving the request, cause the processor to load automatically a partial amount of information from the first application into the volatile memory of the first computer.

21. The system of claim 20 wherein the memory stores instructions that, in response to receiving the request, cause the processor to load on demand a portion of the information into the volatile memory of the first computer in response to a user request.

22. The system of claim 17, wherein the data file is at least one of an image file, a video file, a graphic file, and an audio file.

23. An article comprising a machine-readable medium storing machine-readable instructions that, when applied to the machine, cause the machine to:
compare a first file associated with a first application included on the machine-readable medium of a first computer with a second file associated with a second application on a server, the first file and second file being at least one of a data file and a program module;
construct a database in a volatile memory of the first computer, the database including information on the location of at least one of the first file and second file to load into the volatile memory based on the comparison; and
disseminate information associated with the at least one first and second file using the database in response to the request.

24. The article of claim 23 including instructions that, when applied to the machine, cause the machine to remove the database from the volatile memory in response to a user request.

25. The article of claim 23 including instructions that, when applied to the machine, cause the machine to load automatically a partial amount of information from the first application into the volatile memory of the first computer.

26. The article of claim 25 including instructions that, when applied to the machine, cause the machine to load on demand a portion of the information into the volatile memory of the first computer in response to a user request.
